(19) United States
(12) Patent Application Publication
(10) Pub. No.: US 2018/0148975 A1
(43) Pub. Date: May 31, 2018

(54) GUIDE TRACK ARRANGEMENT

(71) Applicant: INFINITY RETRACTABLE SCREENS PTY LTD, Currumbin Waters (AU)

(72) Inventors: Anthony Gerard Roberts, Currumbin Waters (AU); Aaron Rodd, Currumbin Waters (AU)

(73) Assignee: INFINITY RETRACTABLE SCREENS PTY LTD, Currumbin Waters (AU)

(21) Appl. No.: 15/827,744

(22) Filed: Nov. 30, 2017

(30) Foreign Application Priority Data
Nov. 30, 2016 (AU) 2016904917
Nov. 30, 2016 (AU) 2016904918
Nov. 30, 2016 (AU) 2016904919

(51) Int. Cl. E06B 9/58; E06B 9/54; E06B 1/70; E05D 15/06; E05D 15/26

(52) U.S. Cl. CPC E06B 9/58; E06B 9/54; E06B 1/70; E05D 15/0621; E05Y 2900/136; E06B 2009/587; E06B 2009/543; E06B 9/581; E05D 15/26

(57) ABSTRACT

The disclosure relates to the field of providing a flexible screen which is extensible and retractable across an opening. It is desirable to provide a bottom guide track which is convenient to fit and with a low profile. The disclosed guide track arrangement provides an elongate mounting member for securing to a support that forms part of the opening, and which provides at least one elongate connection recess; and an elongate track member, formed separately from and attachable to the mounting member, and having a track region with an elongate guide recess for slidingly retaining an edge of a flexible screen. The track member has at least one engagement part engageable into the complementary connection recess by lateral movement of the track member to connect the track member to the mounting member.

### CROSS REFERENCE TO RELATED APPLICATIONS

This application claims priority from Australian Provisional Patent Application No. 2016904917 filed 30 Nov. 2016, Australian Provisional Patent Application No. 2016904918 filed 30 Nov. 2016, and Australian Provisional Patent Application No. 2016904919 filed 30 Nov. 2016, the entire disclosures of which are incorporated herein by reference.

### Definition

In the specification, the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

### BACKGROUND OF THE INVENTION

The present disclosure relates to a guide track arrangement for use in guiding an edge of an extensible screen, e.g. a lower edge of a horizontally extensible screen. The present disclosure further relates to components for use with a guide track arrangement for guiding a screen, and to method for installing a screen.

It is known to provide retractable flexible screens which can extend across openings in building structures, such as doors and windows. Some screens, such as those for eliminating or reducing passage of insects, are primarily functional when the associated door or window opening is open. Other types of screens, such as those for eliminating or reducing passage of light, may be used with great utility whether the associated door or window opening is open or closed. Some screens may serve a dual purpose: for example, a screen which is primarily an insect screen may also moderate passage of light and may therefore be useful in its extended position whether the associated door or window opening is open or closed.

One type of retractable screen provides a roller to which a first edge region of a flexible screen material is attached and onto which the flexible screen material is wound so that the screen material can be extended from, and retracted back onto, the roller in a direction perpendicular to the axis of the roller and the first edge region of the screen. The roller may be biased, for example, by a spring, to bias the screen to its retracted position. The edges of the screen perpendicular to the first edge region may be constrained in guide tracks to avoid gaps between these edges and the structure defining the opening and to thereby prevent or reduce unwanted passage of insects or light.

In some known screen arrangements, the guide tracks project a considerable distance from the structure defining the opening, detracting from an attractive appearance of the screen arrangement as a whole.

In some screen arrangements, for example, screen arrangements for bi-fold or stacking doors, the screen extends and retracts horizontally and the top and bottom edges of the screen are retained in guide tracks. In such screens, a bottom track which projects unduly from the part of the structure defining the bottom of the opening may create an unsightly step and may constitute a tripping hazard. Further, a bottom track which is retrofitted close to an existing door may be particularly unsightly and may be conspicuously different in appearance to the frame of the door.

A further issue with some guide track arrangements is that it is difficult and/or costly to manufacture an extruded metal, for example, aluminium, guide track with a channel which retains a lower edge of a screen, allows the screen material to extend from the channel and allows the screen material to slide freely along the guide track.

The reference to prior art or other background in this specification is not, and should not be taken as, an acknowledgment or any form of suggestion that the referenced prior art or other background forms part of the common general knowledge in Australia or in any other country.

### SUMMARY

According to a first aspect of the present disclosure, there is provided a guide track arrangement for retaining an edge of a flexible screen which is extensible and retractable across an opening, the guide track arrangement comprising:
a first elongate member adapted to be secured to a support that at least partially defines the opening, the first elongate member providing an elongate base region and a connection part, wherein the connection part is arranged to provide an elongate connection recess between the base region and the connection part; and
a second elongate member, formed separately from and attachable to the first elongate member, the second elongate member comprising an engagement part engageable in the elongate connection recess to connect the second elongate member to the first elongate member, and further comprising a track region adapted to provide an elongate guide recess for receiving an edge of a flexible screen to allow movement of the edge of the flexible screen in a direction of elongation of the first elongate member.

In an embodiment, the engagement part of the second elongate member is adapted to engage the elongate base region of the first elongate member.

In an embodiment, the engagement part of the second elongate member is adapted to engage the connection part of the first elongate member.

In an embodiment, the engagement part of the second elongate member is adapted to engage both the elongate base region and the connection part of the first elongate member.

In an embodiment, the second elongate member comprises an elongate guide track member.

In an embodiment, the first elongate member comprises an elongate mounting member.

In an embodiment, the first elongate member has a direction of elongation.

In an embodiment, the engagement part of the second elongate member is adapted to be moved into the connection recess by movement of the second elongate member in a direction substantially perpendicular to the direction of elongation of the first elongate member.

In an embodiment, the first elongate member has a lateral direction substantially perpendicular to the direction of elongation of the first elongate member.

In an embodiment, the first elongate member is adapted to be attached to a said support such that it has a depth direction extending substantially in the direction of a plane corresponding to a plane of the opening, and a lateral direction substantially perpendicular to said depth direction and substantially perpendicular to the direction of elongation of the first elongate member.

In an embodiment, the engagement part of the second elongate member is adapted to be moved into the connection recess by movement of the second elongate member substantially in the lateral direction of the first elongate member.

In an embodiment, the elongate base region comprises an elongate base panel.

In an embodiment, the elongate base panel is substantially planar.

In an embodiment, the engagement part of the second elongate member is adapted to be moved into the connection recess by movement of the second elongate member in a direction substantially parallel to a plane defined by the base region.

In an embodiment, the engagement part of the second elongate member is adapted to be moved into the connection recess by movement of the second elongate member in a direction substantially parallel to a plane defined by the substantially planar base panel.

In an embodiment, the engagement part of the second elongate member comprises substantially a single wall thickness of the second elongate member.

In an embodiment, the engagement part of the second elongate member has a thickness no more than five times a wall thickness of the base region of the first elongate member.

In an embodiment, the engagement part of the second elongate member has a thickness no more than three times a wall thickness of the base region of the first elongate member.

In an embodiment, the engagement part of the second elongate member has a thickness no more than twice a wall thickness of the base region of the first elongate member.

In an embodiment, the elongate connection recess has a thickness substantially defined by a spacing between the connection part and the base region.

In an embodiment, the elongate connection recess has a thickness substantially equal to a single wall thickness of the first elongate member.

In an embodiment, the elongate connection recess has a thickness substantially equal to a single wall thickness of the second elongate member.

In an embodiment, the elongate connection recess has a thickness no more than five times a wall thickness of the base region of the first elongate member.

In an embodiment, the elongate connection recess has a thickness no more than three times a wall thickness of the base region of the first elongate member.

In an embodiment, the elongate connection recess has a thickness no more than twice a wall thickness of the base region of the first elongate member.

Reference above to ‘a thickness of the base region of the first elongate member’ may, optionally, be taken to mean ‘a mean thickness of a wall which defines the base region of the first elongate member’.

In an embodiment, the elongate connection recess has an opening at a lateral side thereof for allowing insertion of the engagement part of the second elongate member.

In an embodiment, the elongate connection recess is tapered in a direction of insertion of the engagement part of the second elongate member.

In an embodiment, the second elongate member comprises a base surface adapted to slidingly engage a surface of the base region of the first elongate member.

In an embodiment, the second elongate member provides at least one accommodating recess adapted to accommodate a part of a fastener which protrudes from said surface of the base region of the first elongate member.

In an embodiment, the accommodating recess is at least partially defined by a surface part of the second elongate member which is adjacent to and recessed with respect to said base surface.

In an embodiment, the accommodating recess has a lateral width which is at least as great as a lateral distance required to move the engagement part from a position in which it is not engaged in the elongate connection recess to a position in which it is fully engaged in the elongate connection recess.

In an embodiment, the first elongate member has at least one indicium to assist in positioning a fastener for use in securing the first elongate member to said support.

In an embodiment, said at least one indicium is provided on or in the elongate base region.

In an embodiment, said at least one indicium comprises at least one guide for positioning said fastener.

In an embodiment, said at least one indicium comprises a groove.

In an embodiment, said at least one indicium is elongate. In an embodiment, a direction of elongation of the indicium corresponds to a direction of elongation of the first elongate member.

In an embodiment, the accommodating space is configured to overlie said indicium.

In an embodiment, the accommodating space is configured to accommodate a head of a screw positioned in accordance with the indicium.

In an embodiment, at least two laterally spaced indicia are provided.

In an embodiment, at least two laterally spaced accommodating spaces are provided.

In an embodiment, the connection part of the first elongate member comprises a first connection part arranged to provide a first elongate connection recess between the base region and the first connection part, and the first elongate member further provides a second connection part arranged to provide a second elongate connection recess between the base region and the second connection part.

In an embodiment, each of the first and second connection parts is elongate and extends in a direction of elongation of the first elongate member.

In an embodiment, the first elongate member has a width substantially transverse to a direction of elongation thereof.

A width direction of the first elongate member may be regarded as a lateral direction thereof.

In an embodiment, the first and second connection parts are spaced apart in a width direction of the first elongate member.

In an embodiment, the engagement part of the second elongate member comprises a first engagement part engageable in the first elongate connection recess and the second elongate member further comprises a second engagement part engageable in the second elongate connection recess, to thereby connect the second elongate member to the first elongate member.

In an embodiment, the second elongate member has a width substantially transverse to a direction of elongation thereof.

In an embodiment, the first and second engagement parts are spaced apart in a width direction of the second elongate member.

In an embodiment, the second elongate member provides at least part of the track region substantially between the first and second engagement parts.

In an embodiment, the track region is elongate and extends in a direction of elongation of the second elongate member.

In an embodiment, the second elongate member is integrally formed.

In an embodiment, the second elongate member is substantially uniform in transverse cross sectional shape.

In an embodiment, the second elongate member is formed by extrusion.

In an embodiment, the first and second engagement parts of the second elongate member are adapted to be moved into the respective first and second connection recesses by movement of the second elongate member relative to the first elongate member in a direction substantially perpendicular to the direction of elongation of the first elongate member.

In an embodiment, the first and second engagement parts of the second elongate member are adapted to be moved into the respective first and second connection recesses by movement of the second elongate member relative to the first elongate member in a lateral direction of the first elongate member.

In an embodiment, the guide track arrangement further comprises at least one retaining member for preventing inadvertent disconnection of the second elongate member from the first elongate member.

In an embodiment, the at least one retaining member comprises an elongate retaining member.

In an embodiment, the at least one retaining member comprises an elongate flexible strip of material.

In an embodiment, the at least one retaining member comprises an elongate strip of a plastic or a rubber material.

In an embodiment, the at least one retaining member is insertable between at least part of the first elongate member and at least part of the second elongate member.

In an embodiment, the at least one retaining member is insertable between at least part of the first elongate member and at least part of the second elongate member to restrain the first and second elongate members against relative movement.

In an embodiment, the at least one retaining member is insertable between at least part of the first elongate member and at least part of the second elongate member to restrain the first and second elongate members against relative lateral movement.

In an embodiment, the at least one retaining member is insertable between at least part of the first elongate member and at least part of the second elongate member so that a direction of elongation of the retaining member is, in use, substantially aligned with a direction of elongation of at least one of the first and second elongate members.

In an embodiment, the track region of the second elongate member, comprises a guide rail for guiding a draw bar.

In an embodiment, the elongate guide recess is provided within and substantially aligned with said guide rail.

In an embodiment, the first elongate member comprises a threshold plate part which provides a threshold plate part of a frame for a door opening.

In an embodiment, the threshold plate part comprises a step part adapted to provide a step at a threshold.

In an embodiment, the threshold plate part comprises a tread formation.

In an embodiment, the threshold plate part comprises a guide formation for guiding a door arrangement.

In an embodiment, the threshold plate part comprises a guide formation for guiding a sliding, folding or stacking door arrangement.

In an embodiment, the guide formation comprises a guide channel.

In an embodiment, the first elongate member comprises a seal formation for providing or accommodating a seal for sealing against a door part.

In an embodiment, the threshold plate part comprises the seal formation.

In an embodiment, the seal formation comprises a seal channel for accommodating a sealing strip.

In an embodiment, the first elongate member is integrally formed.

In an embodiment, the first elongate member is substantially uniform in transverse cross sectional shape.

In an embodiment, the first elongate member is formed by extrusion.

In an embodiment, the guide track arrangement comprises a cover which can connect to the first elongate member when the second elongate member is not connected to the first elongate member.

In an embodiment, the cover comprises an engagement part engageable in the elongate connection recess of the first elongate member to connect the cover to the first elongate member.

In an embodiment, the cover is integrally formed.

In an embodiment, the cover is substantially uniform in transverse cross sectional shape.

In an embodiment, the cover is formed by extrusion.

In an embodiment, the cover comprises a tread portion.

In an embodiment, the screen is an insect screen.

In an embodiment, the screen is a screen for reducing transmission of electromagnetic radiation therethrough.

In an embodiment, the screen is a screen for reducing transmission of visible and/or infrared electromagnetic radiation therethrough.

According to a second aspect of the present disclosure, there is provided an elongate guide track member for retaining an edge of a flexible screen which is extensible and retractable across an opening, the guide track member comprising:
a track region adapted to provide:
an elongate guide recess for retaining an edge of a flexible screen to allow movement of the edge of the flexible screen in a direction of elongation of the elongate guide track member; and
a guide rail for guiding a draw bar adapted to draw the flexible screen across the opening, to guide movement of the draw bar in a direction of elongation of the elongate guide track member;
wherein the elongate guide recess is provided substantially within the guide rail.

In an embodiment, the guide rail is adapted to fit within a bottom cavity of a draw bar.

In an embodiment, the guide rail is configured to provide a lower region and a higher region, and the lower region is narrower than the higher region.

In an embodiment, the guide rail is provided with at least one upper terminal surface, which provides a bearing surface for engagement by a brake arrangement of a draw bar.

In an embodiment, the at least one upper terminal surface is substantially planar.

According to a third aspect of the present disclosure, there is provided an elongate draw bar body member for use in a draw bar arrangement for drawing a flexible screen material across an opening, the elongate draw bar body member having a lateral width and providing a retaining formation for retaining a leading edge of the flexible screen material in connection with the draw bar, wherein the retaining formation is provided substantially at the lateral centre of the elongate draw bar body member.

In an embodiment, the retaining formation comprises a retaining channel.

In an embodiment, the elongate draw bar body member has a first lateral side and a second lateral side, and the retaining formation is provided substantially equidistantly between the first and second lateral sides.

In an embodiment, the elongate draw bar body member has an in use leading side which in use is distal from a roller onto which the screen material can be wound and unwound.

In an embodiment, the elongate draw bar body member has a in use following side which in use is closer to said roller.

In an embodiment, the elongate draw bar body member is configured so that in use the sheet of screen material extends from the in use following side of the elongate draw bar body member towards the roller.

According to a fourth aspect of the present disclosure, there is provided a threshold plate arrangement for a door opening, the threshold plate arrangement comprising:
a threshold plate part for a door frame; and
an elongate mounting member part adapted to be secured to a support that at least partially defines the opening, the elongate mounting member part providing an elongate base region and a connection part, for connection thereto of either selected one of:
   an elongate guide track member for retaining an edge of a flexible screen which is extensible and retractable across the door opening, the elongate guide track member being formed separately from and attachable to the elongate mounting member, and comprising a track region adapted to provide an elongate guide recess for receiving an edge of a flexible screen to allow movement of the edge of the flexible screen in a direction of elongation thereof; and
   an elongate cover, attachable to the elongate mounting member to cover said at least one connection part without providing a track region thereof adapted to provide an elongate guide recess for receiving an edge of a flexible screen to allow movement of the edge of the flexible screen in a direction of elongation thereof.

In an embodiment, the threshold plate arrangement according to the fourth aspect is an integrally formed combined frame member for a door opening providing a threshold part of the frame, and a mounting member for attachment of an elongate track member.

In an embodiment, the threshold plate part comprises a step part adapted to provide a step at a threshold.

In an embodiment, the threshold plate part comprises a tread formation.

In an embodiment, the tread formation is provided as an upper surface part of the step.

In an embodiment, the threshold plate part comprises a guide formation for guiding a door arrangement.

In an embodiment, the threshold plate part comprises a guide formation for guiding a sliding, folding or stacking door arrangement.

In an embodiment, the guide formation comprises a guide channel.

In an embodiment, threshold plate arrangement comprises a seal formation for providing or accommodating a seal for sealing against a door part.

In an embodiment, the threshold plate part comprises the seal formation.

In an embodiment, the seal formation comprises a seal channel for accommodating a sealing strip.

The elongate mounting member part may comprise any feature or characteristic of the first elongate member, as set out in relation to the first aspect.

According to a fifth aspect of the present disclosure, there is provided a kit comprising a threshold plate arrangement for a door opening in accordance with the fourth aspect and at least one of:
an elongate guide track member for retaining an edge of a flexible screen which is extensible and retractable across the door opening, the elongate guide track member being formed separately from and attachable to the elongate mounting member, and comprising a track region adapted to provide an elongate guide recess for receiving an edge of a flexible screen to allow movement of the edge of the flexible screen in a direction of elongation thereof; and an elongate cover, attachable to the elongate mounting member to cover said at least
one connection part without providing a track region thereof adapted to provide an elongate guide recess for receiving an edge of a flexible screen to allow movement of the edge of the flexible screen in a direction of elongation thereof.

In an embodiment, the kit comprises both of said elongate guide track member and said elongate cover.

According to a sixth aspect of the present disclosure, there is provided a guide track arrangement for retaining an edge of a flexible screen which is extensible and retractable across an opening, the guide track arrangement comprising:
an elongate guide track member comprising a track region which provides an elongate guide recess for receiving an edge of a flexible screen to allow movement of the edge of the flexible screen in a direction of elongation of the elongate guide track member, the elongate guide recess providing an axially extending opening; and
an elongate guide recess insert, receivable within the elongate guide recess, the elongate guide recess insert comprising a substantially tubular member defining an elongate guide channel therein, with an axially extending opening extending substantially the length thereof, and wherein in use the axially extending opening of the guide recess insert is aligned with, and narrower than, the axially extending opening of the elongate guide recess.

In an embodiment, the elongate guide recess is substantially uniform in transverse cross sectional shape.

In an embodiment, the elongate guide recess insert is substantially uniform in transverse cross sectional shape.

In an embodiment, the elongate guide recess insert provides at least one axially extending rib.

In an embodiment, at least one said axially extending rib is adapted to engage the elongate guide track member to prevent rotation of the guide recess insert relative to the guide track member which would misalign the axially extending opening of the elongate guide recess insert and the axially extending opening of the elongate guide recess.

In an embodiment, at least one said axially extending rib is adapted to extend into the axially extending opening of the elongate guide track member.

In an embodiment, the elongate guide recess insert provides a first axially extending rib extending along a first side of the axially extending opening thereof, and a second axially extending rib extending along a second side of the axially extending opening thereof.

In an embodiment, each of the first and second axially extending ribs is adapted to extend into the axially extending opening of the elongate guide track member.

In an embodiment, the elongate guide track member is made substantially of metal.

In an embodiment, the elongate guide recess insert is made substantially of a plastic.

In an embodiment, the elongate guide track member is manufactured by an extrusion process.

In an embodiment, the elongate guide recess insert is manufactured by an extrusion process.

According to a seventh aspect of the present disclosure, there is provided an elongate guide track member for retaining an edge of a flexible screen which is extensible and retractable across an opening, the guide track member comprising:
a track region adapted to provide an elongate guide recess for receiving an edge of a flexible screen to allow movement of the edge of the flexible screen in a direction of elongation of the elongate guide track member;
and an engagement part engageable in an elongate connection recess provided in a complementary elongate mounting member which is adapted to be secured to a support that at least partially defines the opening.

In an embodiment, the engagement part comprises a lateral edge of the elongate guide track member.

In an embodiment, the engagement part is adapted to be inserted into said elongate connection recess by substantially lateral movement of the guide track member.

In an embodiment, the engagement part comprises a first engagement part engageable in a first elongate connection recess of said elongate mounting member and the elongate guide track member further comprises a second engagement part engageable in a second elongate connection recess of said elongate mounting member, to thereby connect the elongate guide track member to said elongate mounting member.

In an embodiment, the elongate guide track member has a width substantially transverse to a direction of elongation thereof.

In an embodiment, the first and second engagement parts are spaced apart in a width direction of the elongate guide track member.

In an embodiment, the elongate guide track member provides at least part of the track region substantially between the first and second engagement parts.

In an embodiment, the track region is elongate and extends in a direction of elongation of the elongate guide track member.

In an embodiment, the first and second engagement parts of the elongate guide track member are adapted to be moved into the respective first and second connection recesses by movement of the second elongate member in a direction substantially perpendicular to the direction of elongation of the elongate guide track member.

In an embodiment, the first and second engagement parts are adapted to be moved into the respective first and second connection recesses by movement of the elongate guide track member relative to said elongate mounting member in a lateral direction of the elongate guide track member.

According to an eighth aspect of the present disclosure, there is provided a method of installing a bottom guide track for a flexible screen which is extensible and retractable across an opening, the method comprising:
providing a guide track member for retaining an edge of a flexible screen; and
attaching the guide track member to a combination threshold plate and mounting member part to retain an edge of the screen in a guide channel of the guide track member during extension and retraction of the screen.

In an embodiment, the combination threshold plate and mounting member part comprises: an elongate mounting member part providing an elongate base region and a connection part for connection thereto of the guide track member, and; a threshold plate of a door opening.

In an embodiment, the mounting member part is integrally formed with the threshold plate.

In an embodiment, the combination threshold plate and mounting member part is formed by extrusion.

In an embodiment, the method comprises attaching the guide track member to the mounting member part.

In an embodiment, the method comprises attaching the guide track member to the combination threshold plate and mounting member part, after the combination threshold plate and mounting member part has been installed in the opening for at least 30 days.

In an embodiment, the method comprises attaching the guide track member to the combination threshold plate and mounting member part after removal of a cover from the combination threshold plate and mounting member part.

In an embodiment, the method comprises replacing the cover with the guide track member.

In an embodiment, the guide track member comprises an elongate guide track member as set out in the seventh aspect.

In an embodiment, the guide track member comprises an elongate guide track member as set out in relation to any preceding aspect.

In an embodiment, the combination threshold plate and mounting member comprises a threshold plate as set out in the fourth aspect.

According to a ninth aspect of the present disclosure, there is provided a method of installing a bottom guide track for a flexible screen which is extensible and retractable across an opening, the method comprising:
providing a guide track member for retaining an edge of a flexible screen;
removing a cover from a mounting member previously secured in or adjacent the opening by detaching the cover from the mounting member; and
attaching the guide track member to the mounting member to retain an edge of the screen in the guide track member during extension and retraction of the screen.

According to a tenth aspect of the present disclosure, there is provided a guide track arrangement for retaining an edge of a flexible screen which is extensible and retractable across an opening, the guide track arrangement comprising:
an elongate mounting member adapted to be secured to a support that at least partially defines the opening, the elongate mounting member providing an elongate base region having a first lateral side and a second lateral side and a connection part, wherein the connection part is arranged to provide an elongate connection recess between the elongate base region and the connection part; and
an elongate track member, formed separately from and attachable to the elongate mounting member, the elongate track member comprising an engagement part engageable in the elongate connection recess to connect the track member to the mounting member, and further comprising a guide track region comprising an elongate guide recess for receiving an edge of a flexible screen to guide movement of the edge of the flexible screen in a direction of elongation of the elongate mounting member.

In an embodiment, the elongate connection recess has an opening along a lateral side thereof for insertion of the engagement part of the elongate track member.

In an embodiment, the engagement part of the elongate track member is moveable into the connection recess by movement of the elongate track member relative to the elongate mounting member substantially in a lateral direction of the elongate mounting member.

In an embodiment, the elongate connection recess is defined by a first wall of the elongate mounting member and a first return connection part and has a blind side defined by the first wall and an opposite open side facing towards the second lateral side of the elongate mounting member.

In an embodiment, the connection part of the elongate mounting member is a first connection part and the elongate connection recess is a first elongate connection recess, and the elongate mounting member further provides a second connection part arranged to provide a second elongate connection recess between the base region and the second connection part.

In an embodiment, the first and second elongate connection recesses each have an open side facing towards the second lateral side of the elongate mounting member.

In an embodiment, the engagement part of the elongate track member is a first engagement part engageable with the first elongate connection recess and the elongate track member further comprises a second elongate engagement part engageable with the second elongate connection recess.

In an embodiment, one or both of the first elongate connection recess and the second connection recess are tapered away from their open side towards their blind sides.

In an embodiment, the first engagement part comprises a projection that is shaped complementary to the taper of the first elongate connection recess.

In an embodiment, the second engagement part is a projection that is shaped complementary to the taper of the second elongate connection recess.

In an embodiment, the elongate mounting member comprises a securing wall projecting at or adjacent the second lateral side of the base region of the elongate mounting member, the securing wall being arranged to provide an elongate channel between the securing wall and the elongate track member when the elongate track member is connected to the elongate mounting member, and wherein the guide track arrangement further comprises a securing strip that is receivable in the elongate channel to restrict lateral movement of the elongate track member relative to the elongate mounting member which would result in disengagement of the engagement part of the elongate track member from the connection recess.

In an embodiment, the base region comprises an elongate base panel.

In an embodiment, the guide track region is intermediate a first lateral side of the guide track member and a second lateral side of the guide track member.

In an embodiment, the guide track member comprises a first limb extending laterally from the guide track region and terminating in the first engagement part with a first base portion that engages the elongate base panel.

In an embodiment, the guide track member comprises a second limb extending laterally from the guide track region that provides a second base portion for engaging the elongate base panel.

In an embodiment, the second engagement part is connected to the second limb by a bridging portion and the second engagement part has a further base portion for engaging the elongate base panel.

In an embodiment, the guide track region has a guide base portion that engages the elongate base panel, and at least one of the first and second limbs provides an underside which has a recessed surface region that provides an accommodating space between the elongate track member and the elongate mounting member for receiving a head of a fastener used to secure the elongate mounting member to the support.

In an embodiment, the elongate guide recess provides an axially extending opening narrower than a maximum transverse width of the elongate guide recess, and the guide track arrangement further comprises an elongate guide recess insert, receivable within the elongate guide recess.

In an embodiment, the elongate guide recess insert comprises a substantially tubular member defining an elongate guide channel therein, with an axially extending opening extending substantially the length thereof, and in use the axially extending opening of the guide recess insert is aligned with, and narrower than, the axially extending opening of the elongate guide recess.

In an embodiment, the elongate guide recess insert provides at least one axially extending rib adapted to engage the elongate guide track member to prevent rotation of the guide recess insert relative to the guide track member which would misalign the axially extending opening of the elongate guide recess insert and the axially extending opening of the elongate guide recess.

In an embodiment, the guide track region is configured to provide a guide rail for guiding a draw bar adapted to draw the flexible screen across the opening, to guide movement of the draw bar in a direction of elongation of the elongate guide track member, and the elongate guide recess is provided substantially laterally centrally within the guide rail.

In an embodiment, the guide rail is configured to be received within a recess provided at the bottom of said draw bar, the guide rail is configured to provide a proximal region closer to the base region of the elongate mounting member and a distal region further from the base region of the elongate mounting member, and the proximal region is laterally narrower than the distal region.

In an embodiment, the elongate mounting member further comprises an integral threshold plate part.

In an embodiment, the integral threshold plate part provides a step part adapted to provide a step at a threshold.

In an embodiment, the integral threshold plate part provides a tread formation.

In an embodiment, the integral threshold plate part provides a guide formation for guiding a sliding, folding or stacking door arrangement. In an embodiment, the guide formation comprises a door guiding channel.

In an embodiment, the guide track arrangement further comprises a cover attachable to the elongate mounting member when the elongate track member is not connected to the elongate mounting member, the cover comprising an engagement part engageable in the elongate connection recess of the elongate mounting member to connect the cover to the first elongate member.

It will be appreciated that features set out above in relation to any aspect may be incorporated mutatis mutandis in other aspects.

### BRIEF DESCRIPTION OF THE DRAWINGS

Embodiments will be described below, in detail, with reference to accompanying drawings. The primary purpose of this detailed description is to instruct persons having an interest in the subject matter of the invention how to carry the invention into practical effect. However, it is to be clearly understood that the specific nature of this detailed description does not supersede the generality of the preceding statements in the above Summary. In the accompanying diagrammatic drawings:

FIG. 1 is a schematic illustration of an embodiment of a screen arrangement which provides a horizontally extensible and retractable screen, and which includes upper and lower guide tracks for retaining upper and lower edges of the screen;

FIG. 2 is a perspective view of an embodiment of a length of a lower guide track assembly in accordance with the present disclosure, which can be used in the screen arrangement of FIG. 1;

FIG. 3 is a perspective view of an embodiment of a mounting component of the lower guide track assembly of FIG. 2;

FIG. 4 is a perspective view of an embodiment of a guide component of the lower guide track assembly of FIG. 2;

FIG. 5 is a perspective view of the guide component of FIG. 4 adjacent an associated guide insert for facilitating retention of a lower edge of a screen;

FIG. 6 is a perspective view of the guide component and associated guide insert of FIG. 5, with the guide insert fitted within the guide component;

FIG. 7 is an end view of the guide component and associated guide insert of FIG. 6, with the guide insert fitted within the guide component;

FIG. 8 is an end view corresponding to FIG. 7 also showing, in end view, the mounting component of FIG. 3;

FIG. 9 shows in end view an initial step in connecting the guide component and associated guide insert of FIG. 5 to the mounting component of FIG. 3;

FIG. 10 shows in end view a further step in connecting the guide component and associated guide insert of FIG. 5 to the mounting component of FIG. 3;

FIG. 11 shows an end view corresponding to FIG. 10 and further showing a securing strip used to secure the guide component and associated guide insert to the mounting component;

FIG. 12(a) shows an end view corresponding to FIG. 11 and further shows a draw bar of a screen to illustrate complimentary shapes of the guide component and the bottom of the draw bar;

FIG. 12(b) shows an end view corresponding to FIG. 12, but showing the draw bar mounted on the guide component;

FIGS. 13(a) and 13(b) illustrate schematically a truncated bottom portion of the draw bar of FIGS. 12(a) and 12(b) in isolation;

FIG. 13(c) illustrates a cross section of a draw bar body;

FIG. 14 shows in end view the mounting component of FIG. 3 to which a cover, rather than a guide component has been attached;

FIG. 15 corresponds to FIG. 14, but shows a variation of the cover which has a greater height;

FIG. 16 is a perspective view of an end of the guide component and mounting component as shown in FIG. 11, with an end cap provided for fitting to an end of the guide component;

FIG. 17 is a transverse cross sectional view showing engagement of the end cap shown in FIG. 16 with the guide component and mounting component;

FIG. 18 is a transverse cross sectional view of an alternative embodiment in which a mounting component with similarities to the mounting component of FIG. 3 is integrated with a threshold plate for a door, and in which a cover is attached to the integrated mounting component and threshold plate;

FIG. 19 is a transverse cross sectional view showing the integrated mounting component and threshold plate of FIG. 18, but showing a guide component, rather than a cover, attached thereto;

FIG. 20(a) is a transverse cross sectional view showing an alternative embodiment of an integrated mounting component and threshold plate with a cover attached thereto;

FIG. 20(b) is a transverse cross sectional view showing the integrated mounting component and threshold plate of FIG. 20(a), but showing a guide component, rather than a cover, attached thereto;

FIG. 21 is a schematic view, illustrating an embodiment of a screen arrangement, including an integrated mounting component and threshold plate, which provides a horizontally extensible and retractable screen, and in which some parts are shown truncated in a horizontal plane;

FIG. 22 is an end view showing a guide track assembly similar to that illustrated in FIG. 11, but illustrating an alternative embodiment of a mounting component;

FIG. 23 is and end view showing the mounting component of FIG. 22, but showing a cover, rather than a guide component, attached thereto; and

FIG. 24 is an end view illustrating a variation of the mounting component of FIGS. 22 and 23.

### DETAILED DESCRIPTION OF EMBODIMENTS

With reference to the accompanying drawings, embodiments of a guide track arrangement for retaining an edge of a flexible screen will be described.

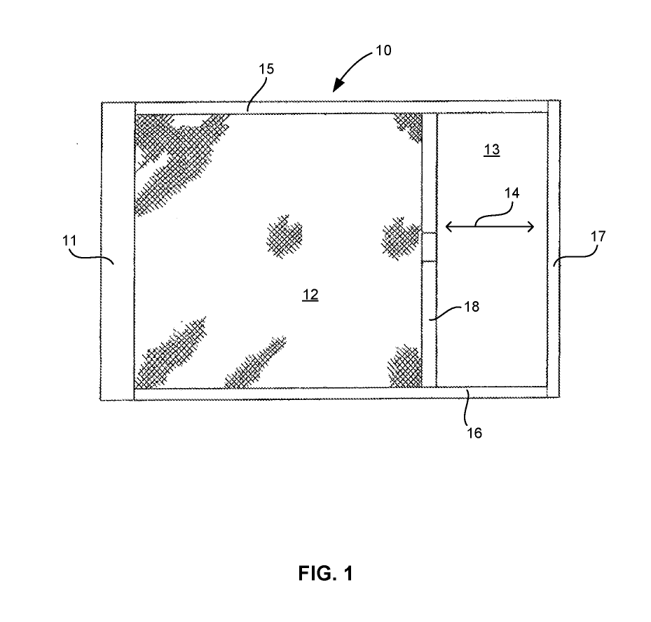

FIG. 1 illustrates schematically a screen arrangement 10, comprising a vertically orientated roller cover 11 which houses a vertically orientated biased roller (not shown) to which a first vertical edge (not shown) of a flexible screen 12 is attached. The flexible screen 12 is wound on the roller so that the screen 12 is extensible across an opening 13, and retractable onto the roller, as indicated by a double headed arrow 14. The roller cover 11, or a frame part (not shown) associated therewith, provides a first upright frame part of the screen arrangement 10. The screen arrangement 10 further comprises an upper guide track 15 which retains an upper edge of the flexible screen 12, a bottom guide track 16 which retains a lower edge of the flexible screen 12, and a second upright frame part 17. The upper and bottom guide tracks 15, 16 extend between the roller cover 11 and the second upright frame part 17. The screen arrangement 10 further comprises a draw bar 18 which is retained between the upper and bottom guide tracks 15, 16 and is moveable between the roller cover 11 and the second upright frame part 17. The draw bar 18 connected to a second vertical edge of the flexible screen 12 opposed to the first vertical edge, so that movement of the drawbar extends or retracts the flexible screen 12.

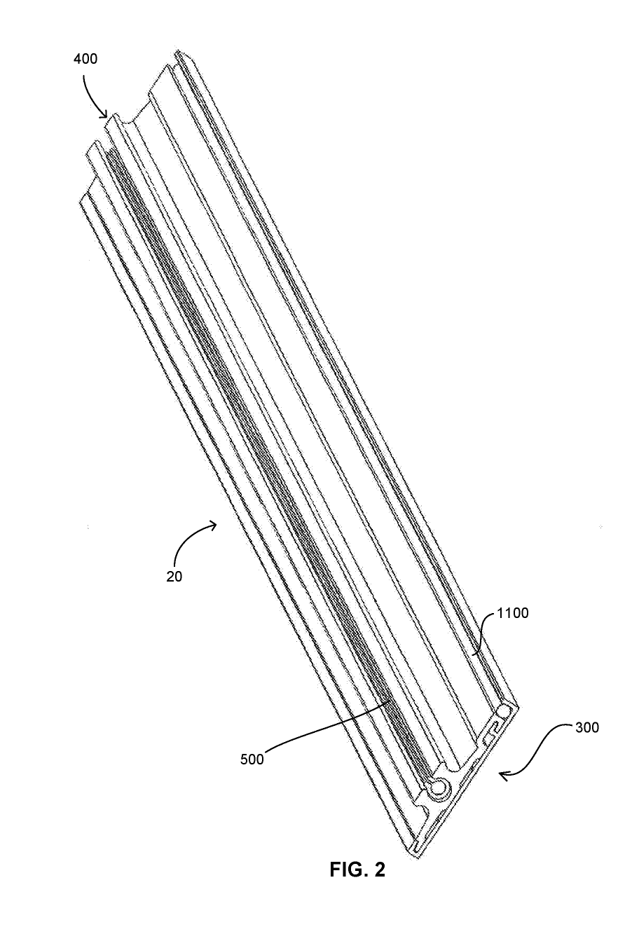

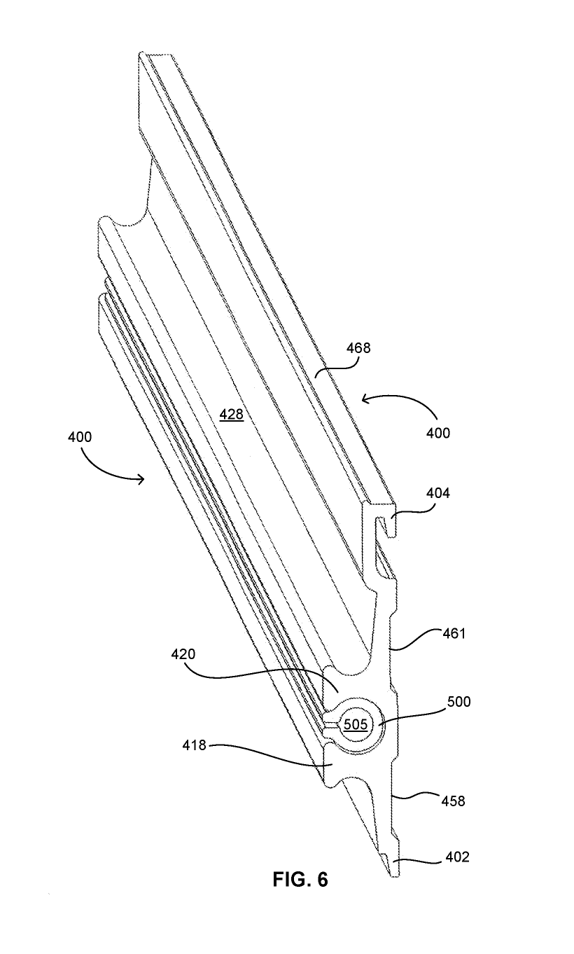

FIGS. 2 to 14 illustrate an embodiment of a guide track arrangement, generally designated 20, in accordance with the present disclosure and various components thereof. The guide track arrangement 20 is suitable for providing the bottom guide track 16 of the screen arrangement 10. The embodiments of the present disclosure are suitable for insect screens, and also applicable to screens for reducing transmission of electromagnetic radiation, and especially but not exclusively, visible and/or infrared electromagnetic radiation, therethrough.

As illustrated in FIG. 2, the guide track arrangement 20 comprises an elongate mounting element 300 which is for attachment to a floor surface or other support at the bottom of the opening in which the screen is to be used. The elongate mounting element 300 is an example of an elongate mounting member and of a first elongate member adapted to be secured to a support that at least partially defines the opening.

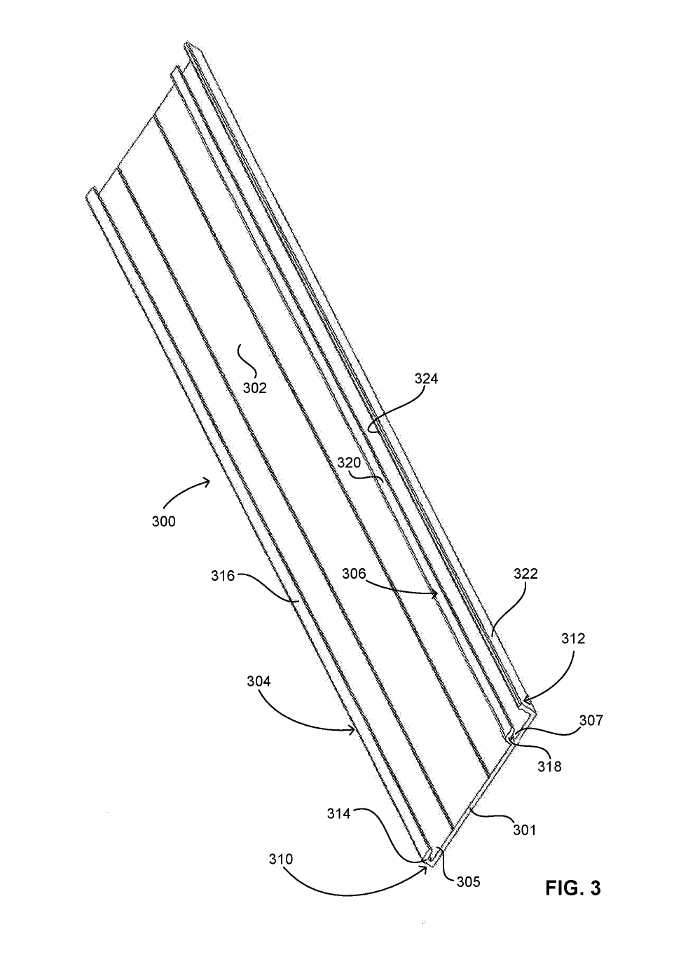

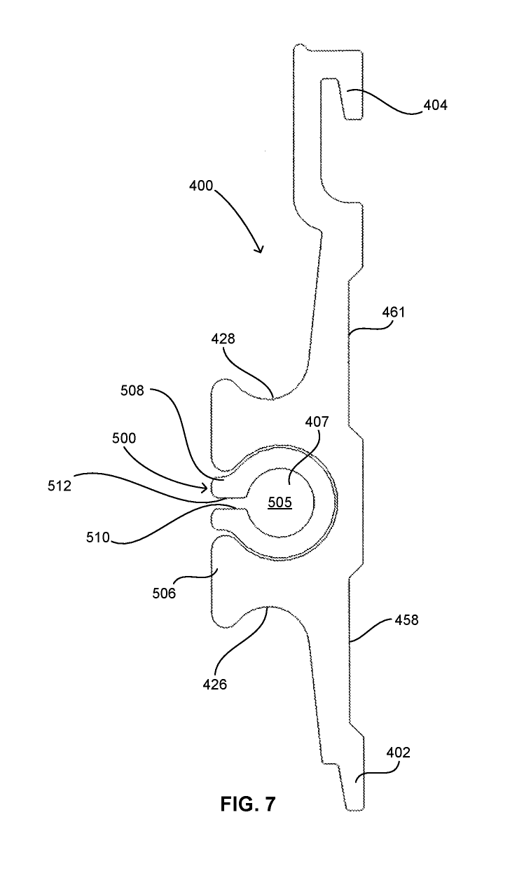

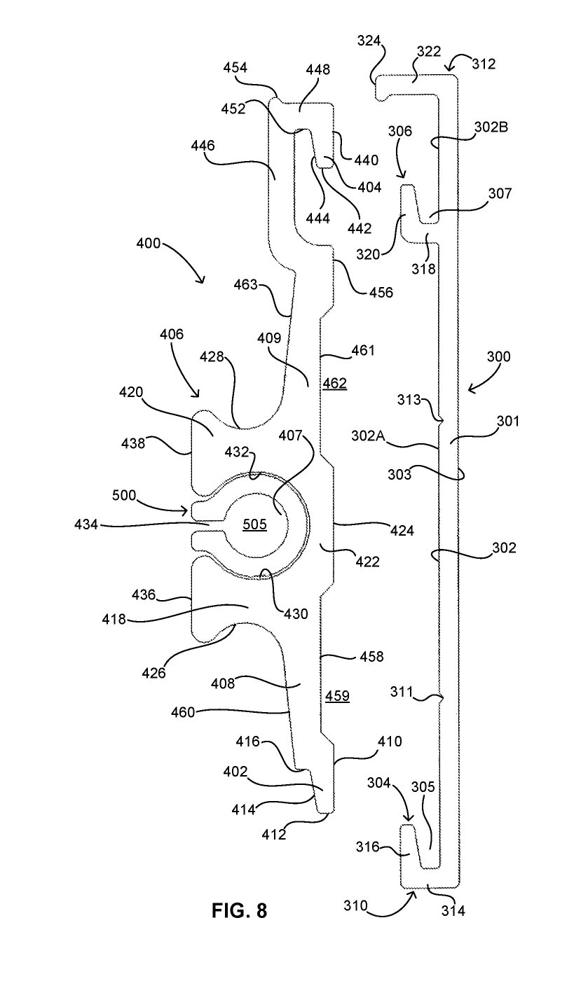

The elongate mounting element 300 is illustrated in isolation in FIG. 3, and is also shown in enlarged end view, which corresponds substantially to transverse cross sectional view, in FIGS. 8 to 11.

The elongate mounting element 300 comprises an elongate base panel 301. The elongate mounting element 300 further comprises first and second connection portions 304, 306, which provide respective first and second connection slots 305, 307 between the respective first and second connection portions 304, 306 and the elongate base panel 301.

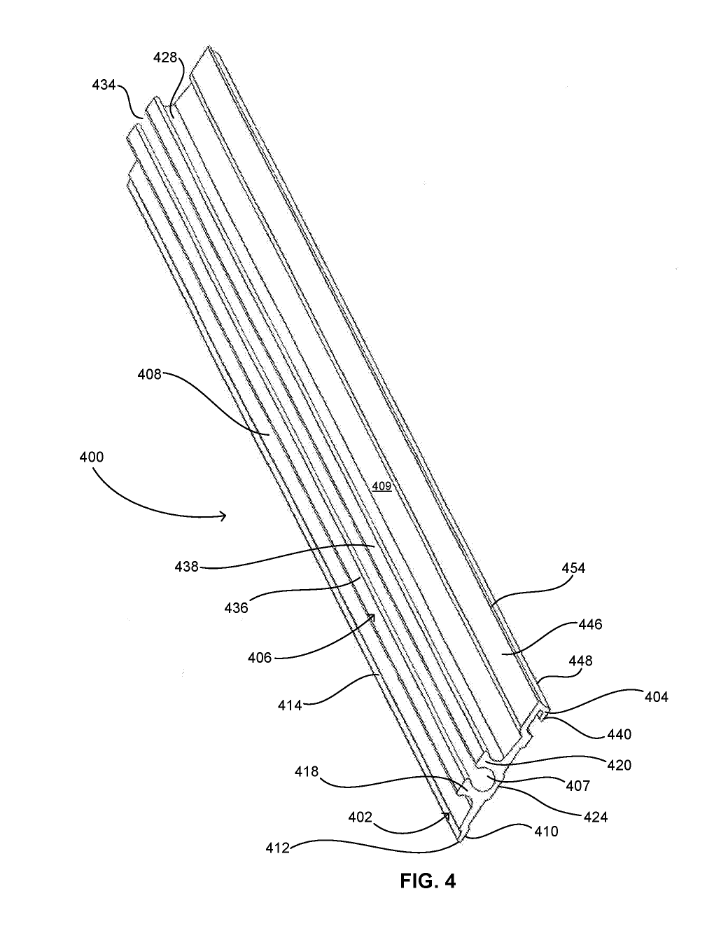

The guide track arrangement 20 further comprises an elongate track element 400 which is formed separately to the elongate mounting element 300, and which can be fixedly attached to the elongate mounting element 300, as will be described in more detail below. The elongate track element 400 is an example of an elongate track member and of a second elongate member, formed separately from and attachable to the first elongate member. The elongate track element 400 is illustrated in isolation in FIG. 4. The elongate track element 400 provides first and second engagement portions 402, 404 adapted to engage in the first and second connection slots 305, 307 of the elongate mounting element 300 to connect the elongate track element 400 to the elongate mounting element 300. The elongate track element 400 further comprises a track portion 406 which provides an elongate guide cavity 407 for receiving an edge of a flexible screen.

The guide track arrangement 20 further comprises a guide cavity insert in the form of a track runner 500, which in use is retained within the elongate guide cavity 407, and a securing strip 1100 which can be applied to retain the elongate track element 400 connected to the elongate mounting element 300, and which can be removed to allow the elongate track element 400 to be detached from the elongate mounting element 300.

With particular reference to FIGS. 3 and 8, the elongate mounting element 300 may be in the form of an elongate extrusion (for example, of aluminium or another suitable metal) which can be cut to a length suitable for use for a particular opening. In such an embodiment, the elongate mounting element 300 may be formed as an integrally formed element, but it should be appreciated that variations, such as elongate mounting members which are formed from two or more parts, are within the scope of the present disclosure.

The elongate base panel 301 extends substantially the width of the elongate mounting element 300 between a first transverse side 310 and a second transverse side 312. The elongate base panel 301 has a first major surface, inner surface 302, which in use faces away from the support to which the mounting element 300 is attached, and a second major surface, outer surface 303, which in use faces towards and contacts the support to which the mounting element 300 is attached.

The elongate mounting element 300 provides one or more indicia or guides to assist a user in positioning screws or other fasteners in order to mount the elongate mounting element 300 to a support surface. In the illustrated embodiment, the one or more indicia or guides comprise first and second shallow grooves 311, 313, provided on the inner surface 302 of the elongate base panel 301, and which extend in the direction of elongation of the elongate mounting element 300.

At the first transverse side 310 the elongate mounting element 300 provides a first wall 314 which projects away from the elongate base panel 301, a short distance. In this embodiment, the first wall 314 projects substantially perpendicularly away from the elongate base panel 301. The first wall 314 terminates, along its edge distal from the elongate base panel 301, in a first return portion 316 which extends away from first wall substantially towards the second transverse side 312 of the elongate mounting element 300. The first wall 314 and first return portion 316 provide the first connection portion 304, which defines the first connection slot 305. The first connection slot 305 is thus elongate and bounded in three of its transverse directions (e.g. left, top and bottom as seen in FIG. 8) by the first wall 314, the first return portion 316, and part of the elongate base panel 301, while being open along its fourth transverse direction (e.g. right as seen in FIG. 8) which faces the second transverse side of the elongate base panel 301.

Close to, but spaced apart from, the second transverse side 312 of the elongate mounting element 300 the second connection portion 306 projects from the elongate base panel 301. The second connection portion 306 comprises a second wall 318 which projects away from the elongate base panel 301, a short distance. In this embodiment, the second wall 318 projects substantially perpendicularly away from the elongate base panel 301. The second wall 318 terminates, along its edge distal from the elongate base panel 301, in a second return portion 320 which extends away from the second wall 318 substantially towards the second transverse side 312 of the elongate mounting element 300. The second wall 318 and second return portion 320 together provide the second connection portion 306, which defines the second connection slot 307. The second connection slot 307 is thus elongate and bounded in three of its transverse-section directions (e.g. left, top and bottom as seen in FIG. 8) by the second wall 318, the second return portion 320, and part of the elongate base panel 301, while being open along its fourth transverse-section direction (e.g. right as seen in FIG. 8) which faces the second transverse side 312 of the elongate base panel 301.

In the illustrated embodiments, the first and second connection slots 305, 307 are tapered, so that they narrow progressively from their open ends to their blind end.

Thus, it will be appreciated that in this embodiment, the shapes of the first and second connection portions 304, 306, are similar to each other and spaced apart in the transverse width direction of the elongate mounting element 300. In this embodiment, the respective first and second connection slots 305, 307 are also similar to each other and spaced apart in the transverse width direction of the elongate mounting element 300.

At the second transverse side 312 of the elongate mounting element 300 there is further wall 322 which projects away from the elongate base panel 301, a short distance but slightly further than do first and second walls 314, 318. In this embodiment, the further wall 322 projects substantially perpendicularly away from the elongate base panel 301. The further wall provides a small retainer projection 324 along its edge distal from the elongate base panel 301, which projects slightly towards the first transverse side 310 of the elongate mounting element 300.

In the illustrated embodiment, the inner surface 302 of the elongate base panel 301 may be regarded as being divided by the second wall 318, into first and second parts, specifically a first part 302A between the first wall 316 and the second wall 318 and a second part 302B between the second wall 318 and the further wall 322. In the illustrated embodiment, the first part 302A is substantially laterally wider that the second part 302B. For example, the second part 302B may be between about 15% and 30% of the width of the first part 302A.

With particular reference to FIGS. 4 to 8, the elongate track element 400 may be in the form of an elongate extrusion (for example, of aluminium or another suitable metal) which can be cut to a length suitable for use for a particular opening. In such an embodiment, the elongate track element 400 may be formed as an integrally formed element, but it should be appreciated that variations, such as elongate track members which are formed from two or more parts, are within the scope of the present disclosure.

The elongate track element 400, in this embodiment, provides the first engagement portion 402 (adapted to engage in the first connection slot 305 of the elongate mounting element 300) extending along a first transverse side of the elongate track element 400. Further, the elongate track element 400, in this embodiment, provides the second engagement portion 404 (adapted to engage in the second connection slot 307 of the elongate mounting element 300) close to a second transverse side of the elongate track element 400. Further, the elongate track element 400, in this embodiment, provides the track portion 406, which provides the elongate guide cavity 407, extending along a transversely generally central region of the elongate track element 400. In this embodiment, the elongate guide cavity 407 is substantially circular in transverse cross section.

The elongate track element 400, in this embodiment, may be regarded as having a transversely generally central region which provides the track portion 406, and as having first and second transversely extending limbs 408, 409. The first engagement portion 402 may be regarded as being provided at a transversely terminal portion of the first transversely extending limb 408, and the second engagement portion 404 may be regarded as being provided at a transversely terminal portion of the second transversely extending limb 409.

The first engagement portion 402 is dimensioned to fit closely in the first connection slot 305, and is thus in the form of a projection having surfaces for engagement with the surface parts of the first wall 314, the first return portion 316, and the elongate base panel 301 which define the first connection slot 305. That is, the first engagement portion 402 has a base surface portion 410 for engaging the elongate base panel 301, a first-side surface portion 412 for approaching and possibly engaging the first wall 314, and a return surface part 414 for engaging the first return portion 316. In this embodiment, the first-side surface portion 412 defines a first side edge of the elongate track element 400.

The first transversely extending limb 408 extends between the first engagement portion 402 and the track portion 406, and a shoulder 416 is provided at the transition between the first transversely extending limb 408 and the first engagement portion 402. In use, the shoulder 416 may abut part of the first connection portion 304. In the particular embodiment illustrated, shoulder 416 may abut the end of the first return portion 316 of the first connection portion 304.

The track portion 406 provides first and second track regions 418, 420 which are laterally adjacent but slightly spaced apart and shaped to define the elongate guide cavity 407 therebetween. The first and second track regions 418, 420 are both connected to a base region 422 of the track portion 406. The base region 422 provides a base surface portion 424 for engagement with the elongate base panel 301 of the elongate mounting element 300.

Each of the first and second track regions 418, 420 has a laterally outwardly facing surface 426, 428, respectively, which faces generally laterally outwardly towards a lateral edge of the elongate track element 400. The laterally outwardly facing surfaces 426, 428 transition into surfaces of the first and second transversely extending limbs 408, 409. In the illustrated embodiment, the laterally outwardly facing surfaces 426, 428 are concave, so that the track portion 406 (formed by the first and second track regions 418, 420) is laterally wider closer to and further from the base region 422, and laterally narrower at an intermediate distance from the base region 422. Thus, the track portion 406 may be regarded as having an ‘hourglass’ shape, and/or an outwardly tapering terminal part distal from the base region 422.

Further, each of the first and second track regions 418, 420 has a laterally inwardly facing surface 430, 432, respectively, which faces generally laterally inwardly, so that the laterally inwardly facing surfaces 430, 432 substantially face each other, and substantially define the elongate guide cavity 407 therebetween. In this embodiment, the laterally inwardly facing surfaces 430, 432 are arcuate in transverse cross section (that is, in the plane perpendicular to the direction of elongation of the elongate track element 400) and define a transverse cross sectional shape of the elongate guide cavity 407 which is generally circular, but which has an opening adjacent the parts of the first and second track regions 418, 420 which are distal from the base region 422. That is, the parts of the first and second track regions 418, 420 which are distal from the base region 422, are spaced apart to provide an elongate opening 434 of the elongate guide cavity 407. It should be appreciated that a guide cavity with a transverse cross section shape other than substantially circular could be used if desired.

Each of the first and second track regions 418, 420 has a terminal surface 436, 438, respectively. The terminal surfaces 436, 438 correspond to the parts of the first and second track regions 418, 420 which are distal from the base region 422. In this embodiment, the terminal surfaces 436, 438 extend between the laterally outwardly facing surfaces 426, 428 and the laterally inwardly facing surfaces 430, 432.

In this embodiment, the first and second track regions 418, 420 which form the track portion 406 may be regarded together as providing a bifurcated track body, which provides a guide rail formation for the draw bar, and in which the guide cavity 407 for guiding an edge of the screen is provided in the guide rail formation. When used with a draw bar which has one or more brakes for selectively inhibiting movement of the draw bar (for example, to resist a force applied by a biased roller) the guide rail formation may also provide a passive braking formation, engageable by one or more brake parts. A draw bar with one or more brakes is disclosed in Australian Patent Application No. 2010241510, the disclosure of which is incorporated herein by reference, and in which a draw bar is referred to as a handle post.

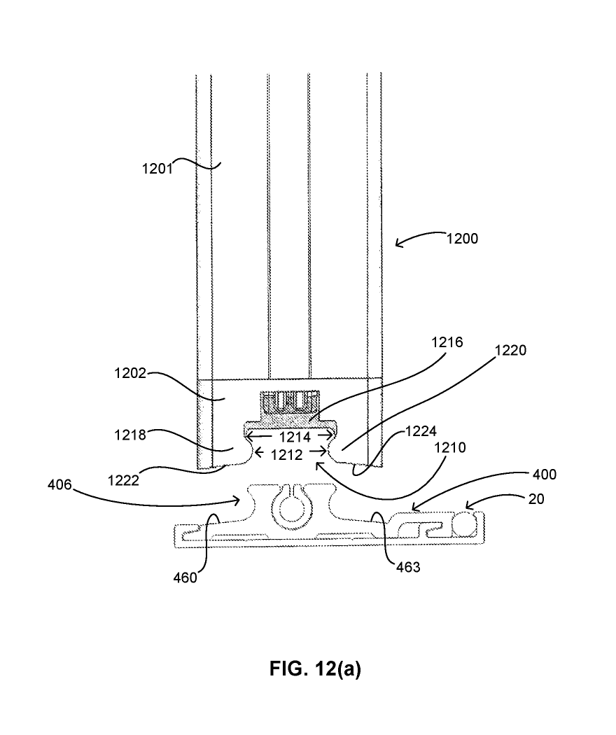

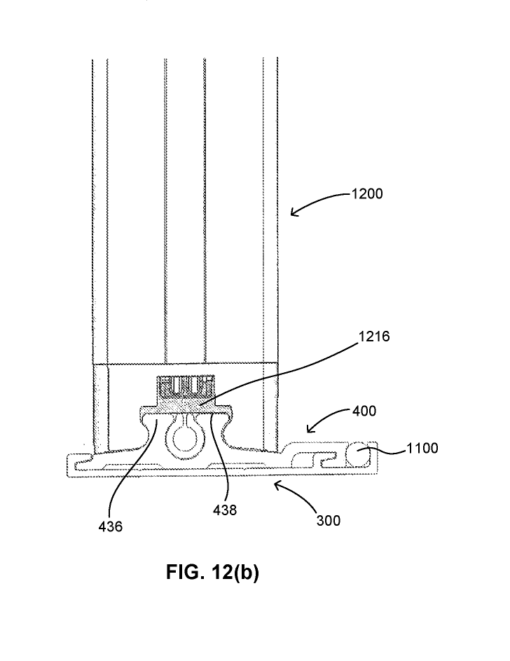

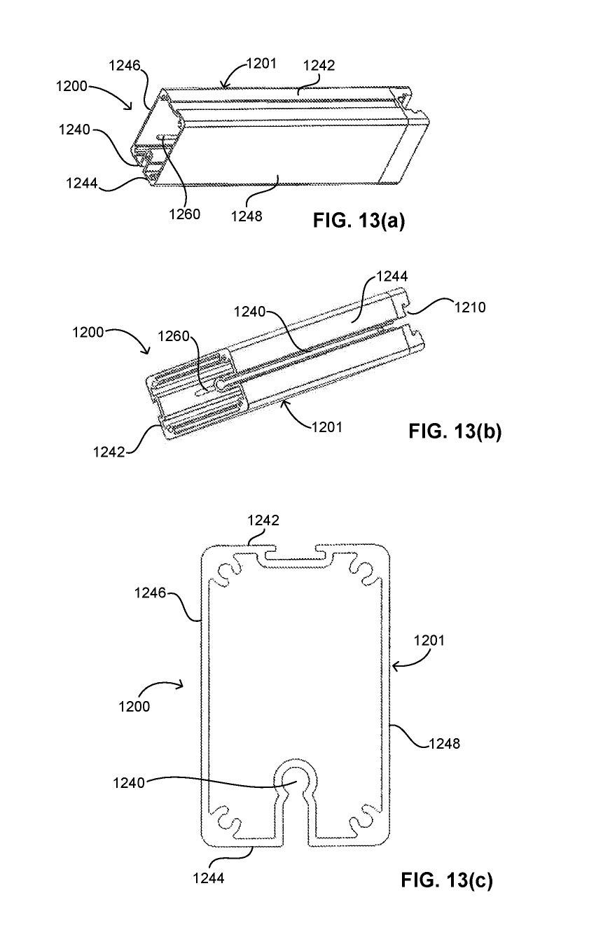

Interaction of the guide rail formation with a draw bar is illustrated in FIGS. 12 and 13 of the present disclosure and will be described in more detail in due course. It will be noted that the cross sectional shape of the track portion 406, as illustrated and as described above (having an ‘hourglass’ shape, and/or an outwardly tapering terminal part, or more generally a part closer to the terminal part that is laterally wider than a part further from the terminal part) allows it to be entrapped within a complementary recess provided at an end of the draw bar, so that the draw bar can be securely retained on and by the track portion 406 (guide rail formation) in use.

The second engagement portion 404 is dimensioned to fit closely in the second connection slot 307, and thus comprises a projection having surfaces for engagement with the surface parts of the second return portion 320 and the elongate base panel 301 (and possibly the second wall 318) which together define the second connection slot 307. That is, the second engagement portion 404 has a base surface portion 440 for engaging the elongate base panel 301, a side surface portion 442 for approaching and possibly engaging the second wall 318, and a return surface part 444 for engaging the second return portion 320.

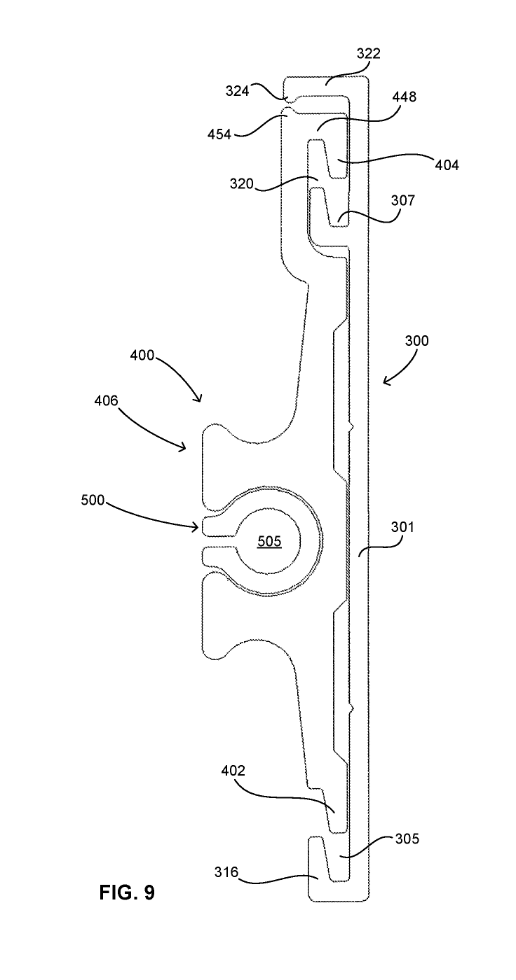

The second engagement portion 404 is connected to the second transversely extending limb 409 by a bridging portion 446. The bridging portion 446 is configured in use to extend over the second connection portion 306 of the elongate mounting element 300, as can be seen in FIGS. 9 to 11, in order to connect the second engagement portion 404 to the second transversely extending limb 409 (and to the rest of the elongate track element 400).

In this embodiment, the bridging portion 446 comprises a second-side wall portion 448 which extends substantially perpendicularly away from the base surface portion 440 and which terminates where it connects to a laterally narrow bridging panel 450. The bridging panel 450 extends substantially parallel to the base surface portion 440 and connects to the second transversely extending limb 409.

In use, a laterally inner wall surface 452 of the second-side wall portion 448 may abut part of the second connection portion 306. In the particular embodiment illustrated, laterally inner wall surface 452 may abut the end of the second return portion 320 of second connection portion 306.

The bridging portion 446 provides a retainer projection 454.

At the transition between the bridging portion 446 and the second transversely extending limb 409, the elongate track element provides a base surface portion 456. In use, the base surface portion 456 engages the inner surface 302 of the elongate base panel 301.

The first transversely extending limb 408 provides a recessed surface 458 between the base surface portion 424 of the track portion 406 and the base surface portion 410 of the first engagement portion 402, which is provided at the distal end of the first extending limb 408. This provides a first accommodating space 459 which in use may accommodate the heads (or parts thereof) of screws or other fasteners used to secure the elongate mounting element 300 to a support. The first transversely extending limb 408 further provides an opposed surface 460 (which is upwardly facing when the elongate track element 400 forms part of a bottom guide track).

The second transversely extending limb 409 provides a recessed surface 461 between the base surface portion 424 of the track portion 406 and the base surface portion 456 provided at the distal end of second transversely extending limb 409. This provides a second accommodating space 462. The second transversely extending limb 409 provides an opposed surface 463 (which is upwardly facing when the elongate track element 400 forms part of a bottom guide track).

The elongate guide cavity 407 provided in the elongate track element 400 is intended to accommodate an edge part of a screen, with the screen material extending out of the elongate guide cavity 407 through the elongate opening 434, and to allow the screen to slide between its extended and retracted positions while being retained along the edges that extend in the direction of movement. The retained edge of the screen includes a retainable edge part which is in use retained in the guide cavity 407, and which may comprise a thickened edge region, a bead, a number of retainable elements (for example, like the teeth of a zip), or the like, as is known per se. In the illustrated embodiment, the elongate opening 434 is sufficiently wide that it would allow a thickened edge part of a screen to pass therethrough. As foreshadowed above, the track runner 500 is, in use, retained within the elongate guide cavity 407.

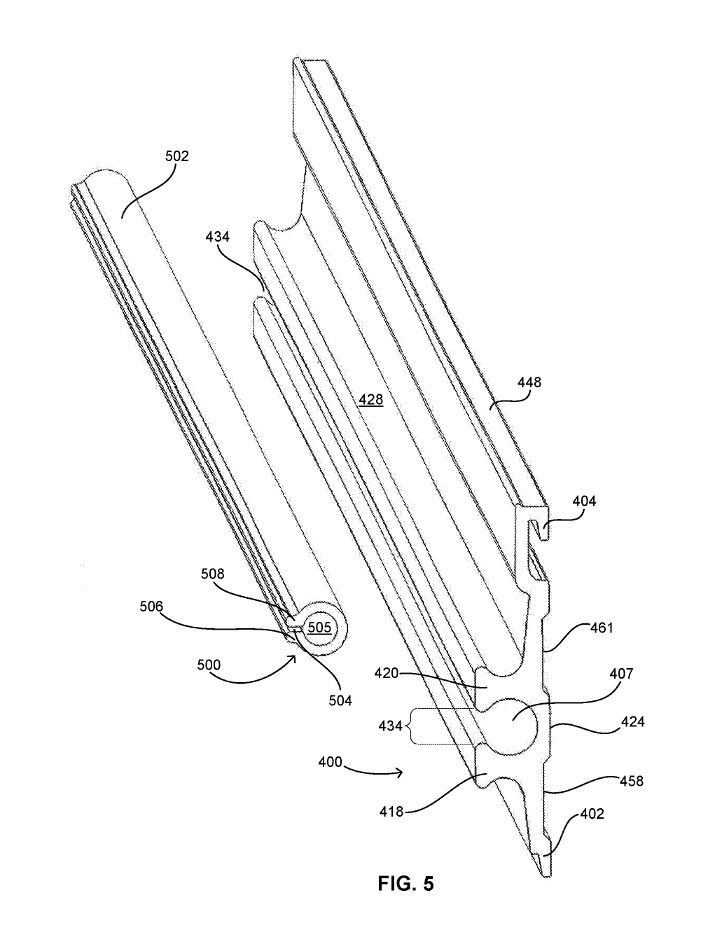

The track runner 500 is illustrated separately to the elongate track element 400 in FIG. 5, and is also shown in enlarged end view, which corresponds substantially to transverse cross sectional view, in FIGS. 8 to 11.

The track runner 500 is an embodiment of a guide recess insert. In this embodiment, the track runner 500 may be regarded as comprising a liner for the elongate guide cavity 407.

The track runner 500 may be made of a suitable plastic, such as (but not limited to) PVC, and may have a coating or additive to assist in reducing friction between the edge of the screen and the track runner 500. For example, the track runner 500 may have a lubricating (or low-friction) material coating provided on the interior surface defining the elongate guide cavity 505, and/or may have a lubricating (or low-friction) material applied to the surface, for example, by application of a spray or the like. The lubricating (or low-friction) material may be PTFE (polytetrafluoroethylene). Additionally or alternatively, the plastic used may have PTFE or some other suitable lubricating (or low-friction) material distributed therethrough.

The track runner 500 comprises a substantially tubular body 502 which provides an axially extending opening 504 which in use defines an opening of a guide channel provided by the elongate guide cavity 407. Thus, an edge of the screen is retained in an elongate guide cavity 505 defined by the track runner 500, which is also within elongate guide cavity 407 defined by the track portion 406. The opening 504 provided by the track runner 500 is, in use, narrower than the opening 434 provided by the track portion 406 when the track runner 500 is not present.

The track runner 500 provides first and second axially extending outwardly projecting ribs 506, 508. These provide an irregularity in the transverse cross sectional shape of the outer surface of the track runner 500 which facilitates rotational alignment of the opening 504 of the track runner with the opening 434 of the elongate guide cavity 407, during insertion of the track runner 500 into the elongate guide cavity 407. The outwardly projecting ribs 506, 508 also help prevent the track runner 500 from rotating or twisting about its axis of elongation in use, to help maintain the alignment of the opening 504 of the track runner with the opening 434 of the elongate guide cavity 407.

In this embodiment, the first and second radially projecting ribs 506, 508 extend along respective opposed edges of the opening 504, and project into the opening 434 defined by the track portion 406. Thus, the ribs 506, 508 also assist in providing opposed opening defining surfaces 510, 512 (see FIG. 7) which define the opening 504 and which extend a greater transverse distance than the mean thickness of the track runner. This may reduce the likelihood of the screen material catching or snagging on the surfaces defining the opening of the guide channel.

The track runner 500 may be manufactured by an extrusion process. The track runner 500 fits reasonably snugly within the elongate guide cavity 407 but the fit allows some movement of the track runner 500 within the elongate guide cavity 407, to allow the track runner 500 to be pushed axially into the elongate guide cavity 407. Further, in certain embodiments, movement and/or deformation of the track runner 500 may reduce or mitigate forces that may be applied to the screen, and therefore also to the thickened edge of the screen located within the track runner 500, in use.

Both the track runner 500 and the surface defining the guide cavity 407 taper inwardly towards the openings 504, 434. In an embodiment, this has the effect that an outwards (upwards in the drawings) force applied to the edge of the screen retained in the track runner (for example, due to a force, such as an impact, applied to the screen) which will tend to force or drag the track runner towards or into the opening 434 will cause the inwardly tapered outer surfaces of the track runner 500 to bear against the inwardly tapered inner wall surfaces of the guide cavity 407, forcing the sides of the opening 504 towards each other and thus narrowing the opening 504. This can assist in retaining the edge of the screen in the elongate guide cavity 505, and in the guide cavity 407, even in the event of application of such a force. This contrasts with use of some known channels for retaining the thickened edge of a screen, in which forcing the thickened edge against the interior of the channel opening tends to force apart the edges of the opening, leading to a risk that part of the thickened edge might pass through the opening and exit the channel and/or wedge in the opening.

When the force is no longer applied, the track runner may revert towards its equilibrium shape (for example, as a consequence of the resilience of the plastic from which it is formed).

In the event of a sideways force on the screen, for example, due to the screen being blown by a strong wind, the track runner 500 can rotate slightly within elongate guide cavity 407, for example, due to the screen pressing against one or other of the opposed opening defining surfaces 510, 512, so that the opening 504 orients in or towards the direction in which the screen is being forced. This can reduce or mitigate forces applied to the screen at or adjacent its thickened edge.

Under some circumstances, the narrowing of the opening 504 and the rotation of the track runner 500 may in response to the same force or forces being applied to the screen.

Provision of a track runner 500, or more generally a plastic/polymer insert which in use defines the elongate opening of the guide channel, can provide a more reliable and/or economical way of providing an opening of the guide channel to a fine tolerance than attempting to manufacture an aluminium extrusion providing a track element which defines the opening itself. It is considered that providing the opening 434 with a uniform width of less than about 1.5 mm would present technical difficulties and/or incur additional cost, whereas use of the track runner 500 allows a substantially uniform width of around 0.5 mm to 1.0 mm to be reliably and economically provided.

A method of installing the guide track arrangement 20 will now be described with particular reference to FIGS. 8 to 11.

The elongate mounting element 300 is secured to a support defining an opening, in the desired position. For the purpose of this description, it is assumed that the guide track arrangement 20 is to be used to provide a bottom track for providing a horizontally opening screen in the corresponding to a set of folding (e.g. bi-fold) or stacking doors, although it should be appreciated that the guide track arrangement 20 may be utilised for other purposes.

Thus, in this example, the elongate mounting element 300 may be secured to part of a floor (not shown). The elongate mounting element 300 may conveniently be secured by use of screws or other fasteners passing through the base panel 301 of the elongate mounting element 300, and positioned in the width direction of the base panel 301 coinciding with the grooves 311, 313.

After the elongate mounting element 300 is secured, the elongate track element 400 (with the track runner 500 already positioned in the elongate guide cavity 407 thereof) is brought close to the mounting element 300, as illustrated schematically in FIG. 8.

To attach the elongate track element 400 to the elongate mounting element 300, the elongate track element 400 is brought into contact with the elongate mounting element 300, as illustrated in FIG. 9. As illustrated, the base surface portions 410, 424, 440 of the elongate track element 400 are brought into contact with the inner surface 302 of the base panel 301, so that the bridging portion 446 overlies the second connection portion 306. This is effected by moving the elongate track element 400 in a direction substantially perpendicular to the base panel 301. At this stage, the first and second engagement portions 402, 404 do not engage (or only incidentally engage) the first and second connection portions 304, 306. Further, it should be appreciated that at this stage of initial engagement the recessed surfaces 458, 461 overlie the grooves 311, 313 where the heads of any screws used to secure the elongate mounting element 300 to the support would be located. Thus, any part of the head of a screw or other fastener used to secure the mounting element 300 to the support which projects beyond the inner surface 302 of the base panel 301 is accommodated in one of the first and second accommodating spaces 459, 462.

The elongate track element 400 is then moved laterally (to the left as shown in FIG. 9), so that the first engagement portion 402, enters and is tightly engaged in the first connection slot 305, and the second engagement portion 404 enters and is tightly engaged in the second connection slot 307, as shown in FIG. 10. It will be appreciated that the recessed surfaces 458, 461 still are of sufficient lateral extent that they overlie the grooves 311, 313 throughout the lateral movement of the elongate track element 400 that moves it from its initially engaged position (FIG. 9) to its position (FIG. 10) where the first and second engagement portions 402, 404 are engaged in the first and second connection slots 305, 307. Thus, any protruding screw are accommodated in one of the first and second accommodating spaces 459, 462, throughout the lateral movement required for connection of the elongate track element 400 to the elongate mounting element 300, and do not interfere with the elongate track element 400 either during connection or during use of the guide track arrangement 20.

Because the first and second engagement portions 402, 404 and the first and second connection slots 305, 307 are tapered, the engagement portions 402, 404 can be regarded as being wedged into the connection slots 305, 307. This effectively prevents movement of the elongate track element 400 in its axial direction. Further, engagement of the engagement portions 402, 404 in the connection slots 305, 307 effectively prevents movement of the elongate track element 400 relative to the elongate mounting element 300 in each direction perpendicular to the plane of the base panel 301 (corresponding to the up and down directions in this example) and in the lateral direction towards the first side of the elongate mounting element 300 (that is to the left as illustrated in FIG. 10).

At this stage (as illustrated in FIG. 10) the elongate track element 400 is not constrained (other than by frictional engagement) against lateral movement in the direction opposite to that required to move the engagement portions 402, 404 into the connection slots 305, 307. Such movement would move the engagement portions 402, 404 out of the connection slots 305, 307, allowing vertical movement of the elongate track element 400 and disconnection from the elongate mounting element 300.

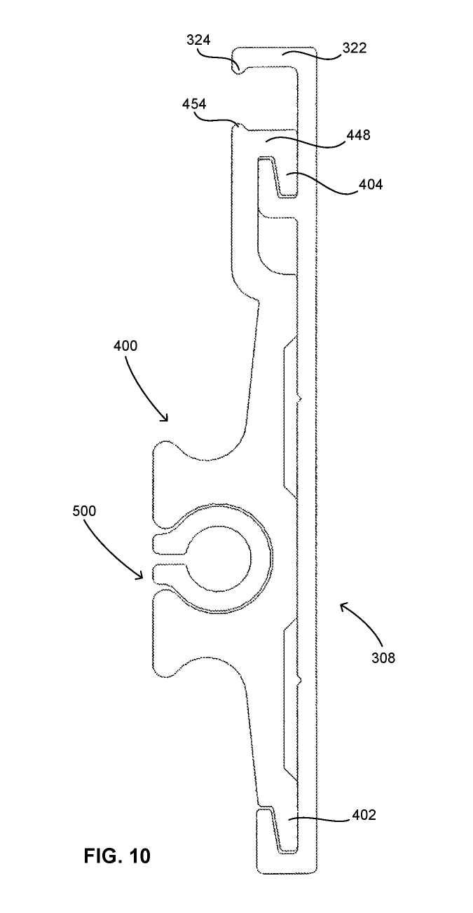

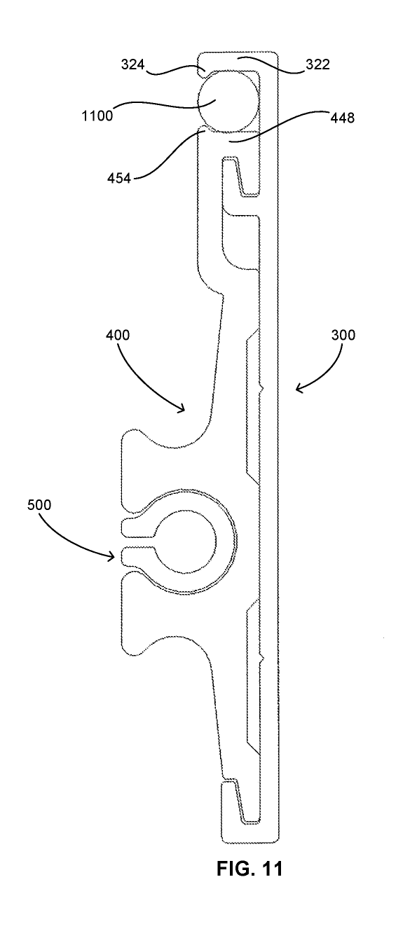

As illustrated in FIG. 11, a securing strip 1100 can be applied to secure the elongate track element 400 against lateral movement in the direction which moves the engagement portions 402, 404 out of the connection slots 305, 307. The securing strip 1100 may comprise any suitable strip-like member, and in this embodiment comprises a flexible chord or spline of the type often used to secure insect screen material to the frame of a screen door. The securing strip 1100 may be made of a flexible PVC material. As illustrated, the securing strip is provided between the second edge of the elongate track element 400 and the second edge of the elongate mounting element 300, and more specifically, in this embodiment, between second-side wall portion 448 (provided at the second edge of the elongate track element 400) and further wall 322 (provided at the second edge of the elongate mounting element 300). The space between the second-side wall portion 448 and the further wall 322 which receives the securing strip 1100 may be regarded as a securing strip recess 1011.

The securing strip 1100 can be inserted into the securing strip recess 1011 in any desired and convenient manner, for example, manually without tools, or by use of a suitable tool such as a spline roller. If and when removal of the securing strip 1100 is desired, removal can be effected by releasing part of the securing strip 1100 from the securing strip recess 1011, for example, using a suitable tool, such as a screwdriver, and then pulling the securing strip progressively out of the securing strip recess.

The securing strip is retained against inadvertent removal by the retaining projections 324, 454.

It will be appreciated from the above that the elongate track element 400 can be attached to the secured elongate mounting element 300 quickly and easily by simply dropping or placing it into the relative position illustrated in FIG. 9, moving it laterally relative to the elongate mounting element 300 to the position illustrated in FIG. 10, and then applying the securing strip 1100, as illustrated in FIG. 11 to substantially secure the elongate track element 400 against movement relative to the elongate mounting element 300. A guide track arrangement 20 of considerable length (for example, using an elongate track element 400 of substantially corresponding length) can be easily assembled in this manner.

The heads of screws (or otherwise exposed parts of other fasteners) used to secure the elongate mounting element 300 are effectively concealed under or behind the elongate track element 400.

Thus, in an embodiment, when the elongate track element 400 (or another element such as a cover, which will be described hereafter) is attached to the elongate mounting element 300, screws (or other fasteners) used to secure the elongate mounting element 300 to a support will not be visible. In particular, the heads of screws which extend through the elongate base panel 301 will not be visible in use. Avoidance of exposed fasteners enhances the aesthetics of the guide track arrangement, which may be a significant consideration in many circumstances.

The disclosed guide track arrangement 20 may have a very low profile. For example, an embodiment in accordance with FIGS. 2 to 11 may have a height of about 12 to 13 mm. In one such embodiment, the total lateral width of the elongate mounting element 300 is about 63 mm, and the total lateral width of the elongate track element 400 is about 56 mm.

That is, the perpendicular distance between the outer surface 303 of the elongate base panel 301 and the terminal surface 436, 438 of the track portion 406, may be about 12 to 13 mm. If the outer surface 303 of the elongate base panel 301 engages and is secured to a floor surface, this equates to the standing height of the guide track arrangement 20.

As foreshadowed above, the provision of a low profile guide track is desirable. A number of features included in the described embodiment are considered to contribute to providing a low profile guide track arrangement, including: the arrangement of the connection between the elongate track element 400 and the elongate mounting element 300; the provision in the elongate track element 400 of accommodating spaces for the heads of fasteners used to secure the elongate mounting element 300 to a support; and the provision of the guide channel within a guide rail for the draw bar.

As foreshadowed above, the shape of the track portion 406 allows it to be entrapped within a complementary recess provided at an end of a draw bar, so that the draw bar can be securely retained on and by the track portion 406 (which provides a guide rail formation) in use.

FIGS. 12(a) and 12(b) illustrate a bottom region of a draw bar 1200 for an extensible roller screen, and show an elongate body element 1201 of the draw bar extending upwardly from a bottom end cap 1202. A shaped bottom cavity 1210 at the bottom of the draw bar 1200 is formed in the bottom end cap 1202.

FIG. 12(a) illustrates the draw bar 1200 in proximity to the guide track arrangement 20 as illustrated in FIG. 11 to aid understanding of complementary shapes, and FIG. 13 illustrates the draw bar 1200 mounted on the guide track arrangement 20.

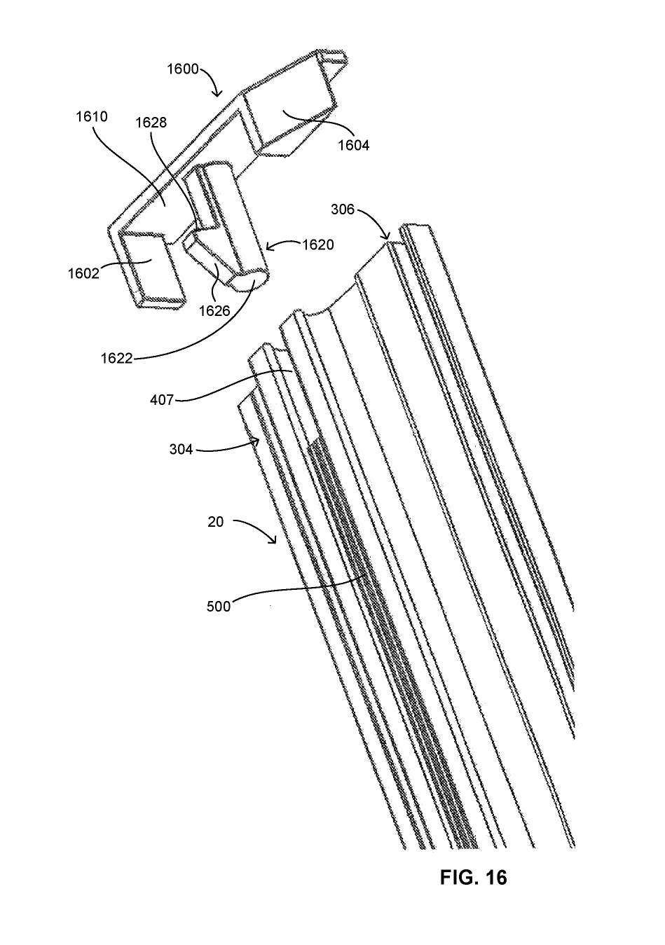

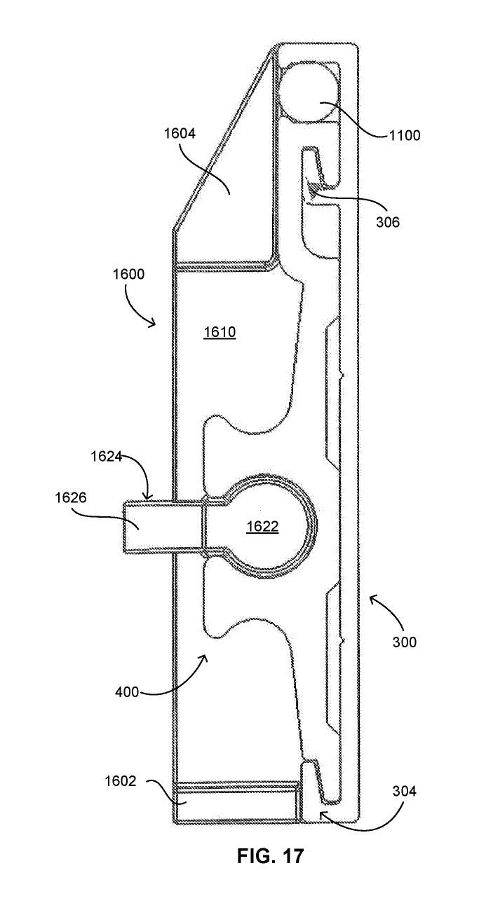

It will be appreciated that the bottom cavity 1210 is shaped to be complementary to the shape of the track portion 406 as described above. That is, the bottom cavity 1210 provides a narrower lower region 1212 (which is slightly wider than the narrowest region of the track portion 406 to allow the draw bar to slide, but narrower than the terminal part of the track portion 406), and a wider upper region 1214 (which is slightly wider than the terminal part of the track portion 406). The bottom region of the draw bar may include a bottom latch mechanism (not shown) for allowing the draw bar to be retained in its fully closed position by a catch provided in the region of the bottom track (see FIGS. 16 and 17). A downwardly biased retractable brake pad 1216 may be provided at or adjacent the wider upper region 1214 to resist a bias force of a roller tending to retract the screen. In FIG. 12(b) the brake pad 1216 is shown in contact with the terminal surfaces 436, 438 of the track portion 406 but it should be appreciated that the brake pad 1216 can typically be retracted, for example, by operation of a handle, by a user wishing to move the draw bar 1200. Any desired and suitable type of handle, brake arrangement and/or bottom latch arrangement may be used. As mentioned above, a draw bar with one or more brakes is disclosed in Australian Patent Application No. 2010241510.

The lower narrower lower region 1212 of the bottom cavity 1210 may be regarded as being defined by first and second lower side portions 1218, 1220 which are spaced apart such that they define a width of the narrower lower region 1212 of the bottom cavity 1210 which is slightly wider than the narrowest region of the track portion 406, but narrower than the terminal part of the track portion 406. In this embodiment, the bottom cavity 1210 is substantially at the lateral centre of the draw bar 1200. First- and second-side bottom surfaces 1222, 1224 of the draw bar 1200 engage respective upwardly facing surfaces 460, 463 of the elongate track element 400, to at least partially support the draw bar on the elongate track element 400. The draw bar 1200 may also, in use, be supported at its other end (for example, its top) by a similar or different arrangement. Because the guide channel provided by the elongate guide cavity 407 is provided substantially at the lateral centre of the guide rail (provided by the track portion 406) the connection of the screen material to the draw bar may easily be configured so it is spaced equidistant to each side of the guide rail, and equidistant to each side of the draw bar 1200.

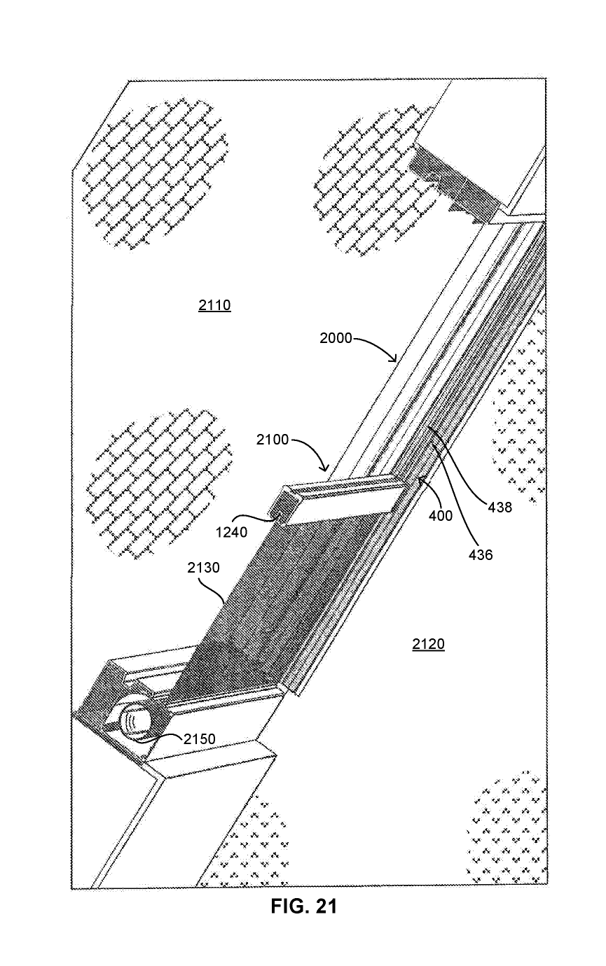

FIGS. 13(a) to 13(c) illustrate an embodiment of a draw bar 1200 which comprises at least one elongate body element 1201 configured with a retaining channel 1240 for retaining a leading edge of the flexible screen material (not shown in FIGS. 12(a) to 13(c), but see FIG. 21). The draw bar 1200 may be regarded as having a leading side 1242 which in use is distal from a roller onto which the screen material can be wound and unwound, a following side 1244 which in use is closer to said roller, and a lateral width extending between first and second lateral sides 1246, 1248 of the draw bar 1200. As foreshadowed above, the retaining channel 1240 is provided substantially laterally centrally in relation to the draw bar 1200, and is also provided substantially laterally centrally in relation to the elongate body element 1201.

As best illustrated in FIG. 13(b) the retaining channel 1240 is provided substantially laterally centrally in relation to the bottom cavity 1210 of the draw bar 1200. This means that the retaining channel 1240 is, in use, substantially aligned with the opening 434, 504 of the guide channel (guide cavity 407, which retains the bottom edge of the screen material).

Thus, the extension of the screen material from the draw bar 1200 into the guide channel (guide cavity 407) is aligned with the lateral centre of the draw bar. Such an arrangement is aesthetically pleasing in its symmetry and can avoid a retraction force applied to the drawbar by the screen, or a short period of higher than normal friction between the screen edge and the interior of the guide channel, imparting substantial torque on the drawbar and its engagement with the guide rail. This can assist smooth running of the draw bar on the guide rail as it slides therealong, for example, between an open position towards the roller onto which the screen material can be wound and unwound and a closed position further away from the roller.

It should be appreciated that the cross sectional shape shown in FIG. 13(c) is of the elongate body element 1201 of the draw bar 1200. The draw bar may include a handle region (not shown) which provides a handle to facilitate movement of the draw bar (and, if applicable, to facilitate disengagement of a brake) and which has a different cross sectional configuration (not shown). The handle region may be at an axially (for example, in use vertically) generally central part of the draw bar and an elongate body element, for example, corresponding to the elongate body element 1201) may be provided on each lateral side (for example, in use above and below) the handle region. FIGS. 13(a) and 13(b) show an optional rod or cable 1260 which may be provided to extend though the elongate body element 1201 to connect a handle to a brake mechanism. The, or each, elongate body element (e.g. 1201) may be formed by extrusion.

Further detail of the draw bar, the handle arrangement and other related subject matter is provided in the Australian patent applications from which this patent application claims priority, the entire contents of which are incorporated herein by reference.

As illustrated in FIGS. 13(a) to 13(c), connection of the screen material to the drawbar may be via engagement of a leading edge of the screen material in a laterally central channel which extends the height of the drawbar, on the side of the drawbar proximal the roller of the screen.

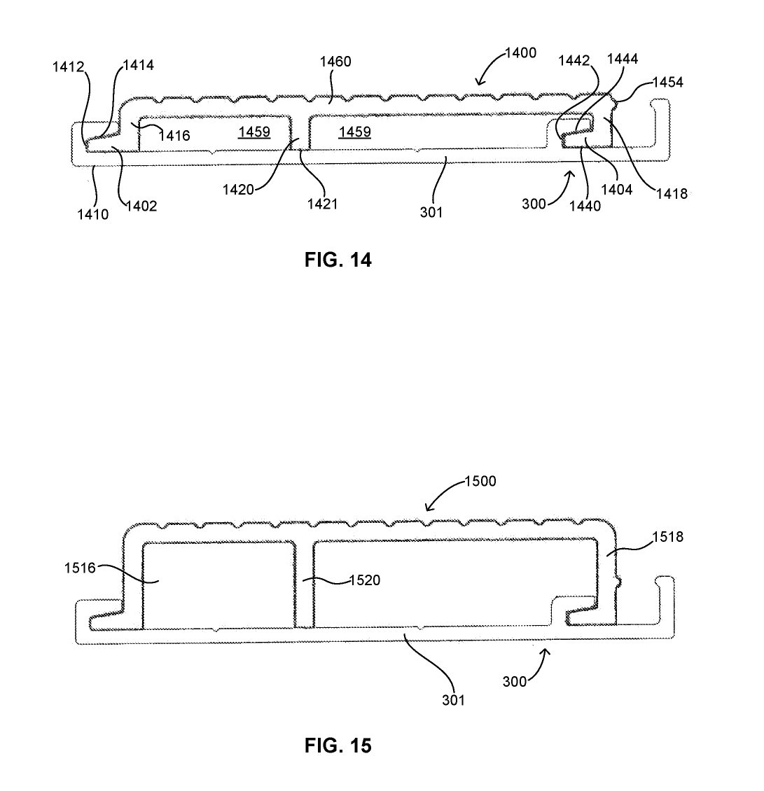

FIG. 14 illustrates a cover 1400, rather than the elongate track element 400, attached to the elongate mounting element 300.

The cover 1400 comprises first and second engagement portions 1402, 1404 which are similar in form and function to the first and second engagement portions 402, 404 provided on the elongate track element 400. The first and second engagement portions 1402, 1404 are dimensioned to fit closely in the first and second connection slots 305, 307, respectively.

The first engagement portion 1402 has a base surface portion 1410 for engaging the elongate base panel 301, a first-side surface portion 1412 for approaching and possibly engaging the first wall 314, and a return surface part 1414 for engaging the first return portion 316. In this embodiment, the first-side surface portion 1412 defines a first side edge of the cover 1400.

The second engagement portion 1404 has a base surface portion 1440 for engaging the elongate base panel 301, a side surface portion 1442 for approaching and possibly engaging the second wall 318, and a return surface part 1444 for engaging the second return portion 320.

The cover 1400 can be mounted to, and demounted from, the elongate mounting element 300 in a manner corresponding to the mounting and demounting of the elongate track element 400 on the elongate mounting element 300. The cover provides a retaining projection 1454 corresponding in function to retaining projection 454.

The cover 1400 further comprises a cover panel 1460, which may be a tread panel suitable for being stepped upon. The cover panel 1460 is supported relative to, and spaced apart from, the first and second engagement portions 1402, 1404 by respective first and second support walls 1416, 1418. The first support wall 1416 connects the cover panel 1460 to the first engagement portion 1402, and the second support wall 1418 connects the cover panel 1460 to the second engagement portion 1404.

In use with the elongate mounting element 300, as illustrated in FIG. 14, the first and second support walls 1416, 1418 (and to some extent the first and second engagement portions 1402, 1404) support the cover panel 1460 away from the base panel 301. Thus, the cover may be regarded as providing at least one accommodating space 1459, which can accommodate protruding heads of screws or the like used to secure the elongate mounting element 300 to a support. The at least one accommodating space 1459 is analogous in function to the first and second accommodating spaces 459, 462 of the elongate track element 400.

In the illustrated embodiment, the cover 1400 has a third, laterally intermediate support wall 1420, which provides a base surface portion 1421 for engaging the base panel 301. The intermediate support wall 1420 may be regarded as dividing accommodating space 1459 into two laterally separated accommodating spaces. The intermediate support wall 1420 is positioned so that it does not adversely affect the function of the at least one accommodating space 1459, that is, so that the cover 1400 can be moved laterally across the base panel 301 in order to mount or demount the cover 1400, without the intermediate support wall 1420 engaging the protruding heads of screws or the like which are located in the grooves 311, 313.

The cover 1400 may be in the form of an elongate extrusion (for example, of aluminium or another suitable metal) which can be cut to a desired length.

The provision of a cover, such as cover 1400, allows an elongate mounting element 300 to be secured adjacent an opening in advance of a need or desire to mount a screen (or elongate track element 400), while covering and protecting the elongate mounting element 300, and providing a more aesthetically pleasing and practical arrangement than would be provided by mounting the elongate track element 400. This can greatly enhance the practicality of securing a mounting element in advance, for example, at the same time as providing a frame for a door, to thereby facilitate future installation of a screen and track element. Further, the cover provides a useful option in the circumstances that a screen is temporarily removed or deliberately temporarily disabled.

FIG. 15 corresponds to FIG. 14 but illustrates an alternative embodiment of a cover, designated 1500, rather than the cover 1400 of FIG. 14. The cover 1500, as illustrated, is substantially identical to the cover 1400 except that the cover 1500 is adapted to extend further from the base panel 301 than is the cover 1400. Where the base panel 301 is provided so that it extends horizontally at the bottom of an opening, this greater extension corresponds to a greater height of the cover 1500.

In this embodiment, the greater extension (height) is provided by providing the cover 1500 with support walls proportioned and dimensioned differently to the support walls 1416, 1418, 1420 of the cover 1400.

In the embodiment illustrated in FIG. 15, the cover 1500 comprises first, second and intermediate support walls 1516, 1518, 1520 corresponding generally to the support walls 1416, 1418, 1420 of cover 1400, but of greater height.

Use of a cover of greater height may be desirable under some circumstances, for example, to align the top surface of the cover with an adjacent surface so that the top surface of the cover and the adjacent cover are substantially coplanar. This can provide enhance appearance in the surround of an opening.

FIG. 16 is a perspective view of an end of the guide track arrangement 20 (comprising elongate mounting element 300 and elongate track element 400) with an end cap 1600 provided for fitting at an end thereof, and FIG. 17 is a transverse cross sectional view showing engagement of the end cap 1600 shown in FIG. 16 with the elongate mounting element 300 and elongate track element 400.

The end cap 1600 comprises an end panel 1610 adapted to abut a transverse end of the guide track arrangement 20. The end cap 1600 provides a first-side member 1602 adapted align with the first lateral side of the guide track arrangement 20 and to overlie an end region of the first connection portion 304.

The end cap 1600 further provides a second-side member 1604 adapted to align with the second lateral side of the guide track arrangement 20 and to overlie an end region of the second connection portion 306. The first- and second-side members 1602, 1604 enhance the appearance of the connection of the guide track arrangement 20 to end panel 1610 of the end cap 1600.

The end cap 1600 further comprises a cavity projection 1620 which projects perpendicular to the end panel 1610 and which is adapted to project a short distance into an end region of the guide cavity 407 that has been left without any of the track runner 500 provided therein. The cavity projection 1620 is sized and shaped to fit closely to the interior walls of the guide cavity 407. The cavity projection 1620 provides an end face 1622 distal from the end panel 1610. The end face 1622 may, in use, abut an end surface of a length of track runner 500 provided in the guide cavity 407.

The cavity projection 1620 further comprises a catch portion 1624 which in use extends through the opening 434 and may provide a catch formation for engagement by, and retention of, a lower latch mechanism provided on the drawbar. This can assist in retaining the drawbar in a position corresponding to the fully extended (closed) position of the screen. The catch portion 1624 provides a ramp portion 1626 on a side which in use faces towards the roller of the screen, to enable the lower latch of the drawbar to ride up and over the catch portion 1624 merely by movement of the drawbar, and an abutment portion 1628 on a side which in use faces away from the roller of the screen to provide capture of the latch, unless it is deliberately released, when the drawbar is in a position corresponding to the fully extended (closed) position of the screen. This can allow the latch to be engaged automatically upon full extension of the screen, but to require deliberate and/or manual release in order to allow movement of the drawbar from that position in the retraction direction of the screen.

The end cap 1600 can be attached to the elongate track element 400, by insertion of the cavity projection 1620 into the guide cavity 407, before the elongate track element 400 is attached to the elongate mounting element 300 (as described above) so that it does not interfere with the attachment of the elongate track element 400 to the elongate mounting element 300.

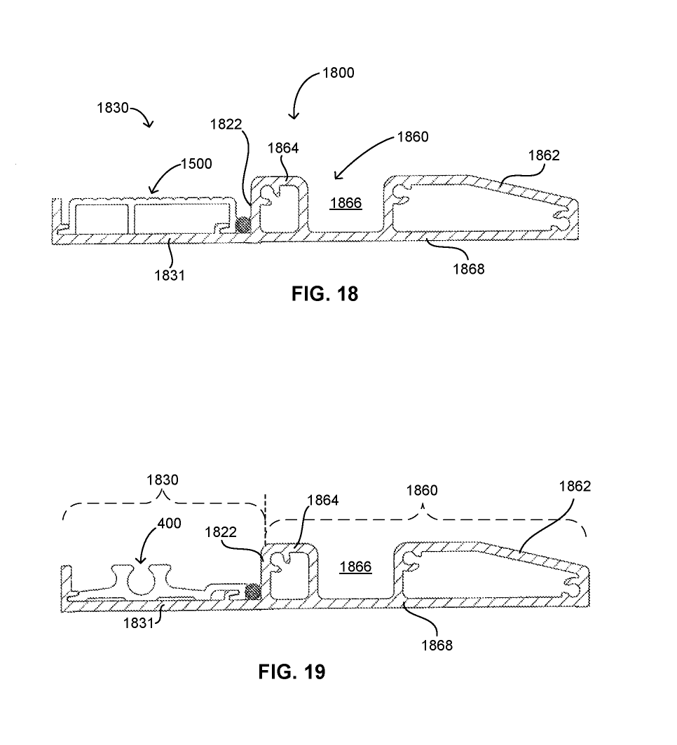

FIG. 18 is a transverse cross sectional view of an alternative embodiment in which a mounting portion with substantial similarities to the elongate mounting element 300 of FIG. 3 is integrated with a threshold plate for a door, to provide an integrated mounting portion and threshold plate 1800, and in which a cover 1500 is attached thereto. FIG. 19 is a transverse cross sectional view showing the integrated mounting portion and threshold plate 1800 of FIG. 18, but showing a guide track part, similar or identical in structure and function to the elongate track element 400, rather than the cover 1500, attached thereto.

As illustrated in FIGS. 18 and 19, the integrated mounting portion and threshold plate 1800 comprises a mounting portion region 1830 which may, for example, be similar in form and function to the mounting portion 300, and a threshold region 1860 which in use is substantially underlies a door or door assembly.

In the illustrated embodiment, the threshold region 1860 comprises an upstanding step section or tread section 1862 and an upstanding guide section 1864, which together define a door channel 1866 for accommodating part of door arrangement (for example, of a sliding, folding and/or stacking door). In the illustrated embodiment, the door channel 1866 is provided between the tread section 1862 and the guide section 1864.

In the illustrated embodiment, the tread section 1862, guide section 1864, and door channel 1866 share a common base panel portion 1868.

The mounting portion region 1830 is provided adjacent the threshold region 1860 to facilitate mounting and operation of an extensible screen adjacent a door arrangement which is accommodated by the door channel 1866. In the illustrated embodiment, an upstanding wall 1822 of mounting portion region 1830, is common with a wall part of the threshold region 1860. For example, the upstanding wall 1822 may correspond substantially to the further wall 322 of elongate mounting element 300, may substantially define a second edge of the mounting portion region 1830, and may be common with a wall of the guide section 1864.

The mounting portion region 1830 may comprise a base panel portion 1831. The base panel portion 1831 may corresponding generally to the base panel 301 of elongate mounting element 300. The base panel portion 1831 (of the mounting portion region 1830) may be substantially coplanar with the base panel portion 1868 (of the threshold region 1860).

The base panel portion 1831 (of the mounting portion region 1830) may be substantially coplanar with the base panel portion 1868 (of the threshold region 1860).

It will be appreciated that the integrated mounting portion and threshold plate 1800 may be of low profile, and that the height of the mounting portion region 1830, whether having a cover (e.g. cover 1500) or a track element (e.g. elongate track element 400) attached thereto may be less than the height of the threshold region 1860. The threshold region 1860 of the integrated mounting portion and threshold plate 1800 can be of the same height as an alternative, known, threshold plate that does not include a mounting portion region for providing a guide channel for a horizontally extensible screen.

Thus use of the integrated mounting portion and threshold plate 1800 can allow a mounting component for providing a guide channel for a horizontally extensible screen to be conveniently provided at the same time a threshold plate for a door is provided, to facilitate installation of a horizontally extensible screen at generally the same time as the door, or at some later time as desired. This can be achieved in a manner in which installation of the mounting component is integral with the mounting of the threshold plate, rather than a separate operation, saving time and therefore cost.

Further, the mounting component does not result in a greater height (or higher profile) of the integrated mounting portion and threshold plate 1800, compared to a threshold plate that does not include a mounting portion region for providing a guide channel for a horizontally extensible screen.

Further use of a cover, such as cover 1500, which can be replaced by a suitable track element (such as elongate track element 400) as and when desired, can provide an arrangement that is more attractive and robust than installation of a track element long before installation of a screen.

Further, the mounting component and threshold plate, being parts of a single component (and the cover and track element, being specifically for use therewith) may easily be provided to have visual harmony, for example, well-matched colour, shape, etc.

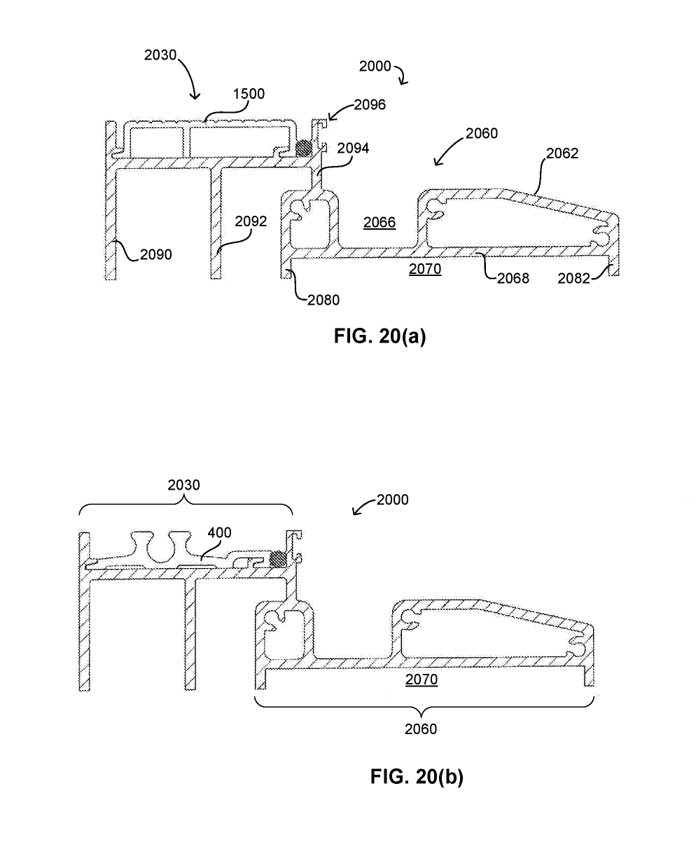

FIGS. 20(a) and 20(b) show an alternative integrated mounting portion and threshold plate, generally designated 2000, which has many similarities to the integrated mounting portion and threshold plate 1800 of FIGS. 18 and 19.

In the integrated mounting portion and threshold plate 2000, a mounting portion region 2030 (with similarities to mounting portion region 1830) is provided adjacent a threshold region 2060 (with similarities to threshold region 1860) to facilitate mounting and operation of an extensible screen adjacent a door arrangement. The threshold region 2060 is provided with support walls 2080, 2082, which may be regarded as extending downwardly from a base panel portion 2068 (corresponding broadly to base panel portion 1868). Further, the mounting portion region 2030 is provided with support walls 2090, 2092, and is also connected by a further support wall 2094 to an upper region of the threshold region 2060.

A significant difference between the integrated mounting portion and threshold plate 2000 and the integrated mounting portion and threshold plate 1800, is that the integrated mounting portion and threshold plate 2000 provides a higher overall profile. The integrated mounting portion and threshold plate 2000 is configured to provide the mounting portion region 2030 so that in use it is located somewhat higher than the threshold region 2060 (whereas in the integrated mounting portion and threshold plate 1800, the mounting portion region 1830 is, in use, substantially level with the threshold region 1860).

The integrated mounting portion and threshold plate 2000 is suitable for use in providing a bottom frame part of a door opening between an internal floor surface and an external ground surface where the internal floor surface is higher than the external ground surface. That is, the integrated mounting portion and threshold plate 2000 may be located on the exterior ground surface, with the outermost support wall 2082 and an associated tread section or external step section 2062 (corresponding somewhat to tread section 1862) providing an external step at a height between that of the external ground surface and that of the internal floor surface, and with the height and configuration of the mounting portion region 2030 being such that the cover (for example, cover 1500) and/or elongate track element 400 is substantially aligned with the interior floor surface. That is, the uppermost part or the cover (for example, cover 1500) and/or elongate track element 400 may be arranged to be substantially aligned with the interior floor surface. Thus, in an embodiment, the integrated mounting portion and threshold plate 2000 is configured so that in use, the top surface or cover panel of the cover (for example, cover 1500), and/or the terminal surfaces 436, 438 of the track portion 406 of the elongate track element 400, are in use substantially aligned and flush with the interior floor surface.

Of course, various embodiments may be provided to provide different step heights and/or to accommodate different height differences between an internal floor surface and an external ground surface, for example, (but not limited to) by providing support walls 2080, 2082, 2090, 2092, 2094 of appropriate heights.

In the illustrated embodiment, the integrated mounting portion and threshold plate 2000 provides a channel 2066 for accommodating and guiding part of a door arrangement. In this embodiment, the channel 2066 is provided between the external step section 2062 and the mounting portion region 2030.

In the illustrated embodiment, the integrated mounting portion and threshold plate 2000 provides a seal formation 2096 which provides or accommodates a seal for sealing against a door part (not shown) when the door arrangement is in a closed configuration. In the illustrated embodiment, the seal formation provides a seal channel for accommodating a sealing strip, such as a rubber or brush seal.

In the illustrated embodiment, the integrated mounting portion and threshold plate 2000 provides a drainage region to allow water such as rainwater or condensation to drain therefrom, and especially to allow water to drain from the channel 2066. In the illustrated embodiment, the drainage region is in the form of a void 2070 provided below the channel 2066 and/or the step section 2062. In this embodiment, the void 2070 is provided by the support walls 2080, 2082 being configured to space at least part of the rest of the threshold region 2060 above a surface on which the integrated mounting portion and threshold plate 2000 is to be secured.

That is, in a particular embodiment, the void 2070 is defined by the support walls 2080, 2082 and the base panel portion 2068. In use, apertures (not shown) are provided to allow water to drain from the channel 2066 into the void 2070. The water may then drain from the void 2070, for example, under the support wall 2082 and/or through drainage apertures or channels provided either in the support wall 2082 or otherwise.

FIG. 21 is a schematic view, illustrating an embodiment of a screen arrangement 2100, including an integrated mounting component and threshold plate, for example, integrated mounting component and threshold plate 2000, to which an elongate track element, for example, elongate track element 400, is attached. The screen arrangement 2100 provides a horizontally extensible and retractable screen, operable by a draw bar, for example, draw bar 1200. Some parts are shown truncated in a horizontal plane to illustrate detail that would otherwise not be visible.

FIG. 21 shows an external ground surface 2110 and an internal floor surface 2120, the external ground surface 2110 being lower than the internal floor surface 2120. The external step section 2062 of the integrated mounting component and threshold plate 2000 provides an upper tread surface which is elevated above the external ground surface 2110, but which is (in this embodiment, although not necessarily) lower than the internal floor surface 2120.

As foreshadowed above, the integrated mounting component and threshold plate 2000 is configured so that it supports the elongate track element 400 so that an upper surface thereof (in this embodiment, the terminal surfaces 436, 438 of the first and second track regions 418, 420) are substantially level with the internal floor surface 2120.

It will be appreciated that the integrated mounting component and threshold plate 2000 may be installed before it is established whether it is desired to provide a screen for the opening. A cover, for example, cover 1500, may be attached to the integrated mounting component and threshold plate 2000 so that (in the absence of, or prior to installation of, a screen) the integrated mounting component and threshold plate 2000 functions substantially as a threshold plate only. The upper surface of the cover may be substantially level with and aligned with the internal floor surface. When, or if, it is desired to provide a screen, the cover (for example, 1500) may be removed and replaced with a track member, for example, elongate track element 400. Thus use of an integrated mounting component and threshold plate can substantially facilitate fitting of a screen a substantially after (for example, 30 days or more after) installation of the integrated mounting component and threshold plate.

As foreshadowed above, in the description of FIGS. 12 and 13, the connection of screen material 2130 to the drawbar 1200 comprises engagement of a leading edge of the screen material 2130 in a laterally central channel 1240 which extends the height of the drawbar 1200, on the side of the drawbar 1200 proximal a roller 2150 of the screen arrangement 2100.

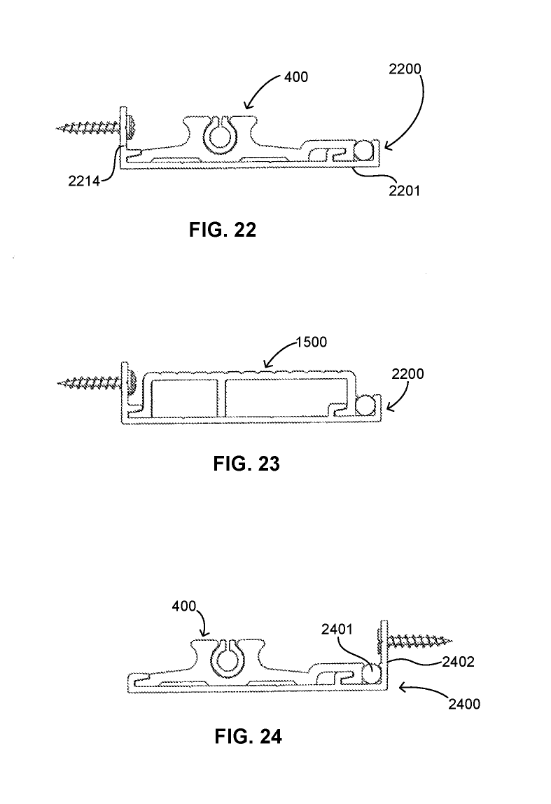

FIGS. 22 to 24 illustrate alternative embodiments of elongate mounting elements.

FIG. 22 illustrates an alternative embodiment of an elongate mounting element, designated 2200. The elongate mounting element 2200 is similar to the elongate mounting element 300, except that a first wall 2214 (corresponding substantially to first wall 314 of elongate mounting element 300) is extended away from the base panel 2201 (corresponding substantially to base panel 301 in elongate mounting element 300) to allow securing by screws (or other appropriate fasteners) to a surface perpendicular to the base panel 2201. This can reduce the number of screws that need to be inserted into the support surface which the base panel 301, 2201 overlies. For example, when the elongate mounting element 2200 is to be secured to a floor, this can reduce the number of screws that need to be inserted into the floor. This may be useful, for example, if the floor is of a material into which it is more difficult to insert screws (for example, stone or marble) and a tread plate adjacent to which the mounting element 2200 is to be fixed is of a material into which it is less difficult to insert screws (for example, timber). It should, similarly, be appreciated that securing an elongate mounting element by using fasteners extending through a wall extending away from, for example, perpendicular from, a base panel of the elongate mounting element may also be convenient for embodiments where the base panel is spaced apart from an underlying surface, as is the case in, for example, the integrated mounting portion and threshold plate 2000.

The elongate track element may be the same as elongate track element 400.

FIG. 23 illustrates the elongate mounting element 2200 having a cover used therewith. The cover may be the same as the cover 1500 of FIG. 15 as shown in FIG. 23, or if desired a different form of cover, for example, the cover 1400 of FIG. 14, could be used.

FIG. 24 illustrates a further alternative embodiment of an elongate mounting element, generally designated 2400, in which a securing spline 2401 (corresponding generally in form and function to securing strip 1100) is insertable into (and removable from) a receiving space provided close to an edge wall 2402 which is adapted to be secured to a surface perpendicular to the base panel.

It will be appreciated that the embodiments of mounting elements (e.g. mounting element 300, being an embodiment of a mounting member) and track elements (e.g. elongate track element 400, being an embodiment of a track member) may be manufactured as extrusions, and that each mounting element and each track element can be in the form of a single integrally formed unit or piece. However, it should be appreciated that it is within the scope of the present disclosure to provide alternative embodiments in which one or each said member is manufactured other than by extrusion, and/or comprises two or more constituent parts.

It will be appreciated that embodiments described herein can provide a number of working advantages over at least some known guide tracks for blinds, and especially to some known guide tracks for blinds which provide bottom tracks for horizontally extensible blinds which open across doorways where folding and/or stacking door arrangements are provided.

Provision of the guide cavity 407 within the guide rail for the draw bar can contribute to the ability to provide a low profile embodiment of a guide track arrangement 20.

The connection arrangement as illustrated and described above, which provides connection slots 305, 307 into which engagement portions 402, 404 can be slid, by lateral sliding movement of the elongate track element 400 relative to the elongate mounting element 300, can further contribute to the ability to provide a low profile embodiment. As illustrated, in an embodiment the thickness of the connection slots 305, 307 and engagement portions 402, 404 (in the direction perpendicular to the elongate base panel 301) is substantially the same as the wall thickness of the extrusions which provide the elongate track element 400 and the elongate mounting element 300, which can assist in providing a very compact connection.

The provision of one or more accommodating spaces 459, 462 in the underside of the elongate track element 400, can further assist in providing a low profile embodiment.

Provision of a cover 1400 substitutable for the elongate track element 400 and attachable to the elongate mounting element 300 in a corresponding manner can assist in providing an elongate mounting element 300 installable in advance of installation of a screen, in a manner which reduces or avoids inconvenience in doing so.

Providing a combined mounting member and door threshold plate 1800 can facilitate installation, in advance, of a mounting element, and can allow a screen to be installed more easily at a later time, while not adding unduly to the difficulty of initially installing the door frame and threshold plate.

The use of an insert 500 can facilitate manufacturing of the elongate mounting element 300 while allowing an opening of desired width to be provided to a high level of accuracy.

Of course, the above features or functionalities described in relation to the embodiments are provided by way of example only. Modifications and improvements may be incorporated without departing from the scope of the invention.

1. A guide track arrangement for retaining an edge of a flexible screen which is extensible and retractable across an opening, the guide track arrangement comprising:
an elongate mounting member adapted to be secured to a support that at least partially defines the opening, the elongate mounting member providing an elongate base region having a first lateral side and a second lateral side and a connection part, wherein the connection part is arranged to provide an elongate connection recess between the elongate base region and the connection part; and
an elongate track member, formed separately from and attachable to the elongate mounting member, the elongate track member comprising an engagement part engageable in the elongate connection recess to connect the track member to the mounting member, and further comprising a guide track region comprising an elongate guide recess for receiving an edge of a flexible screen to guide movement of the edge of the flexible screen in a direction of elongation of the elongate mounting member.

2. The guide track arrangement of claim 1, wherein the elongate connection recess has an opening along a lateral side thereof for insertion of the engagement part of the elongate track member, and wherein the engagement part of the elongate track member is moveable into the connection recess by movement of the elongate track member relative to the elongate mounting member substantially in a lateral direction of the elongate mounting member.

3. The guide track arrangement of claim 1, wherein the elongate connection recess is defined by a first wall of the elongate mounting member and a first return connection part and has a blind side defined by the first wall and an opposite open side facing towards the second lateral side of the elongate mounting member.

4. The guide track arrangement of claim 3, wherein the connection part of the elongate mounting member is a first connection part and the elongate connection recess is a first elongate connection recess, wherein the elongate mounting member further provides a second connection part arranged to provide a second elongate connection recess between the base region and the second connection part, and the first and second elongate connection recesses each have an open side facing towards the second lateral side of the elongate mounting member, and wherein the engagement part of the elongate track member is a first engagement part engageable with the first elongate connection recess and the elongate track member further comprises a second elongate engagement part engageable with the second elongate connection recess.

5. The guide track arrangement of claim 4, wherein the first elongate connection recess and the second connection recess are each tapered away from their open side towards their blind sides, wherein the first engagement part comprises a projection that is shaped complementary to the taper of the first elongate connection recess and the second engagement part is a projection that is shaped complementary to the taper of the second elongate connection recess.

6. The guide track arrangement of claim 2, wherein the elongate mounting member comprises a securing wall projecting at or adjacent the second lateral side of the base region of the elongate mounting member, the securing wall being arranged to provide an elongate channel between the securing wall and the elongate track member when the elongate track member is connected to the elongate mounting member, and wherein the guide track arrangement further comprises a securing strip that is receivable in the elongate channel to restrict lateral movement of the elongate track member relative to the elongate mounting member which would result in disengagement of the engagement part of the elongate track member from the connection recess.

7. The guide track arrangement of claim 4, wherein the base region comprises an elongate base panel, the guide track region is intermediate a first lateral side of the guide track member and a second lateral side of the guide track member, and the guide track member comprises a first limb extending laterally from the guide track region and terminating in the first engagement part with a first base portion that engages the elongate base panel, a second limb extending laterally from the guide track region that provides a second base portion for engaging the elongate base panel, the second engagement part is connected to the second limb by a bridging portion and the second engagement part has a further base portion for engaging the elongate base panel.

8. The guide track arrangement of claim 7, wherein the guide track region has a guide base portion that engages the elongate base panel, and at least one of the first and second limbs provides an underside which has a recessed surface region that provides an accommodating space between the elongate track member and the elongate mounting member for receiving a head of a fastener used to secure the elongate mounting member to the support.

9. The guide track arrangement of claim 1, wherein the elongate guide recess provides an axially extending opening narrower than a maximum transverse width of the elongate guide recess, and wherein the guide track arrangement further comprises an elongate guide recess insert, receivable within the elongate guide recess, the elongate guide recess insert comprising a substantially tubular member defining an elongate guide channel therein, with an axially extending opening extending substantially the length thereof, and wherein in use the axially extending opening of the guide recess insert is aligned with, and narrower than, the axially extending opening of the elongate guide recess.

10. The guide track arrangement of claim 9, wherein the elongate guide recess insert provides at least one axially extending rib adapted to engage the elongate guide track member to prevent rotation of the guide recess insert relative to the guide track member which would misalign the axially extending opening of the elongate guide recess insert and the axially extending opening of the elongate guide recess.

11. The guide track arrangement of claim 1, wherein the guide track region is configured to provide a guide rail for guiding a draw bar adapted to draw the flexible screen across the opening, to guide movement of the draw bar in a direction of elongation of the elongate guide track member, and wherein the elongate guide recess is provided substantially laterally centrally within the guide rail.

12. The guide track arrangement of claim 11, wherein the guide rail is configured to be received within a recess provided at the bottom of said draw bar, and wherein the guide rail is configured to provide a proximal region closer to the base region of the elongate mounting member and a distal region further from the base region of the elongate mounting member, and the proximal region is laterally narrower than the distal region.

13. The guide track arrangement of claim 1, wherein the elongate mounting member further comprises an integral threshold plate part which provides one or more of: a step part adapted to provide a step at a threshold; a tread formation; a guide formation for guiding a sliding, folding or stacking door arrangement.

14. The guide track arrangement of claim 1, further comprising a cover attachable to the elongate mounting member when the elongate track member is not connected to the elongate mounting member, the cover comprising an engagement part engageable in the elongate connection recess of the elongate mounting member to connect the cover to the first elongate member.

15. A threshold plate arrangement for a door opening, the threshold plate arrangement comprising:
a threshold plate part for a door frame; and
an elongate mounting member part adapted to be secured to a support that at least partially defines the opening, the elongate mounting member part providing an elongate base region and a connection part, for connection thereto of either selected one of:
an elongate guide track member for retaining an edge of a flexible screen which is extensible and retractable across the door opening, the elongate guide track member being formed separately from and attachable to the elongate mounting member, and comprising a track region adapted to provide an elongate guide recess for receiving an edge of a flexible screen to allow movement of the edge of the flexible screen in a direction of elongation thereof; and
an elongate cover, attachable to the elongate mounting member to cover said at least one connection part without providing a track region thereof adapted to provide an elongate guide recess for receiving an edge of a flexible screen to allow movement of the edge of the flexible screen in a direction of elongation thereof.

16. The threshold plate arrangement of claim 15, wherein the threshold plate arrangement further comprises the elongate cover.

17. The threshold plate arrangement of claim 15, wherein the elongate connection recess is defined by a first wall of the elongate mounting member part and a first return connection part and has a blind side defined by the first wall and an opposite open side facing towards the second lateral side of the elongate mounting member, wherein the connection part of the elongate mounting member is a first connection part and the elongate connection recess is a first elongate connection recess, wherein the elongate mounting member further provides a second connection part arranged to provide a second elongate connection recess between the base region and the second connection part, and the first and second elongate connection recesses each have an open side facing towards the same lateral side of the elongate mounting member part.

18. A method of installing a bottom guide track for a flexible screen which is extensible and retractable across an opening, the method comprising:
providing a guide track member for retaining an edge of a flexible screen;
removing a cover from a mounting member previously secured in or adjacent the opening by detaching the cover from the mounting member; and
attaching the guide track member to the mounting member to retain an edge of the screen in the guide track member during extension and retraction of the screen.

19. The method according to claim 18, wherein:
the mounting member is elongate, is adapted to be secured to a support that at least partially defines an opening, and provides an elongate base region having a first lateral side and a second lateral side and a connection part, wherein the connection part is arranged to provide an elongate connection recess between the elongate base region and the connection part; and
the guide track member is formed separately from and attachable to the elongate mounting member, the guide track member comprising an engagement part engageable in the elongate connection recess to connect the track member to the mounting member, and further comprising a guide track region comprising an elongate guide recess for receiving the edge of the flexible screen to guide movement of the edge of the flexible screen in a direction of elongation of the elongate mounting member.

20. The method according to claim 18, wherein the mounting member comprises a combination threshold plate and mounting member part, and wherein the method comprises attaching the guide track member to the combination threshold plate and mounting member part, after the combination threshold plate and mounting member part has been installed in the opening for at least 30 days.
